(19) United States
(12) Patent Application Publication
(10) Pub. No.: US 2015/0358476 A1
(43) Pub. Date: Dec. 10, 2015

(54) System for conducting packet service telecommunications on non-packet enabled devices

(71) Applicant: Jose Julian Flores-Estrada, San Antonio, TX (US)

(72) Inventor: Jose Julian Flores-Estrada, San Antonio, TX (US)

(21) Appl. No.: 14/731,762

(22) Filed: Jun. 5, 2015

Related U.S. Application Data
(60) Provisional application No. 62/008,426, filed on Jun. 5, 2014.

(51) Int. Cl. H04M 15/00; H04L 12/66; H04W 8/26; H04M 7/12; H04L 29/06

(52) U.S. Cl. CPC H04M 15/56; H04M 7/1205; H04L 65/1046; H04W 8/26; H04L 12/66; H04M 15/7556; H04M 15/852; H04M 15/58

(57) ABSTRACT

A method for initiating Voice over Internet Protocol communication includes receiving, by a Voice over Internet Protocol switch, data identifying a call-originating phone and data identifying at least one recipient device. The method includes creating, by the Voice over Internet Protocol switch, a first Voice over Internet Protocol call to the call-originating phone using the data identifying the call-originating phone. The method includes creating, by the Voice over Internet Protocol switch, a second Voice over Internet Protocol call to the at least one recipient device using the data identifying the at least one recipient device, and combining, by the Voice over Internet Protocol switch, the first call with the second call.

### TECHNICAL FIELD

Embodiments disclosed herein relate generally to methods and systems for telecommunications, and in particular to the use of call initiation systems for voice communication.

### BACKGROUND ART

Voice over Internet Protocol (VoIP) is a protocol whereby any Internet-enabled device may place a phone call using the Internet. VoIP frees phone service from traditional phone lines and cellular networks, resulting in phone service that is often more robust and less expensive than traditional phone service. For international calls in particular, VoIP is an increasingly popular choice due to its low cost and flexibility. However, many potential users are currently unable to take advantage of VoIP because at the moment they need to place a call, they do not have access to an Internet-enabled device, whether through poverty or a lack of access to appropriate services for geographical reasons.

A challenge in providing simple to use, low-cost packet based phone calls for a Caller using a phone without Internet access is for the Caller to make the call and communicate to the VoIP switch necessary information such as the long distance phone number to dial, the identity of a prepaid account or billed-to account, and the status or balance of an account. Strategies for communicating the desired long distance phone number and handling the payment thereof for text-enabled phones without Internet access have so far centered around prepaid phone cards, text messaging call-back requests to designated, preregistered text-enabled phones from proprietary distributers, and purchase of dedicated forwarding virtual phone number(s) by the party in one country who wishes to be called by Callers in another foreign country. All three strategies require substantial up-front costs to the end-user while providing inadequate service in return. Prepaid phone cards must be repeatedly purchased by the user, and require a long and often frustrating dialing process involving the prepaid card service's number, a card-specific code, and the destination number, and will interrupt the phone call when the prepaid balance runs out. Because preregistered phones for texting call-back methods are identified by current systems using their device identifiers, they must be specially purchased, such that new users cannot take advantage of the service without purchasing a new phone. The user cannot switch phones except by purchasing another pre-registered phone if the user wishes to continue using the service, and has no way to use the service by borrowing another person's phone, for instance if the specially-purchased phone needs to be recharged. The use of a forwarding virtual number typically requires the user to purchase the use of that number on an ongoing basis, resulting in the ability of any user calling the number to make VoIP calls for which the purchasing user will have to pay.

### SUMMARY OF THE EMBODIMENTS

In one aspect, a method for initiating Voice over Internet Protocol communication includes receiving, by a Voice over Internet Protocol switch, data identifying a call-originating phone and data identifying at least one recipient device The method includes creating, by the Voice over Internet Protocol switch, a first Voice over Internet Protocol call to the call-originating phone using the data identifying the call-originating phone. The method includes creating, by the Voice over Internet Protocol switch, a second Voice over Internet Protocol call to the at least one recipient device using the data identifying the at least one recipient device. The method includes combining, by the Voice over Internet Protocol switch, the first call with the second call.

In a related embodiment, receiving further involves receiving, from the call-originating phone, the data identifying the call-originating phone and the data identifying at least one recipient device. In another related embodiment, receiving includes receiving, via non-packet-based network communication, the data identifying the call-originating phone and the data identifying at least one recipient device from the call-originating phone. In another embodiment, the non-packet-based network communication is a text message. In an additional embodiment, the non-packet-based network communication is a phone call placed using the first publically switched telephone network. In yet another embodiment, the Voice over Internet Protocol switch receives the data via the user's voice input in response to a series of prompts provided by the Voice over Internet Protocol switch. In another embodiment still, the data identifying the call-originating phone further includes a first telephone number associated with the call-originating phone. In a further method, the data identifying the call-originating phone further includes data identifying a first country within which call-originating phone is located. In an additional embodiment, the data identifying the call-originating phone further includes data identifying a first person or entity associated with the call-originating phone. In another embodiment, the data identifying the at least one recipient device further includes a first IP address associated with the call-originating phone. In another embodiment, the data identifying the at least one recipient device further includes a second telephone number associated with the at least one recipient device.

Another related embodiment involves detecting, by the Voice over Internet Protocol switch, that the second telephone number does not include a country code, retrieving, by the Voice over Internet Protocol switch, a first country code associated with the second telephone number, and automatically appending, by the Voice over Internet Protocol switch, the first country code to the second telephone number. In an additional embodiment, the Voice over Internet Protocol switch receives the first country code in the data identifying the call-originating phone. In another embodiment, the data identifying the at least one recipient device further includes a second country within which the at least one recipient device is located. In yet another embodiment, the data identifying the at least one recipient device further includes data identifying at least one second person or entity associated with the recipient device. In another embodiment still, the data identifying the at least one recipient device further includes a second IP address associated with the at least one recipient device.

In an additional embodiment, creating the first Voice over Internet Protocol call further involves creating the first Voice over Internet Protocol call using a using a first publically switched telephone network. In a further embodiment, creating the second call further includes creating a Voice over Internet Protocol session with the at least one recipient device using a packet-based network communication protocol. In a further embodiment still, creating the second call further includes creating a telephone call using a second publically switched telephone network to the recipient device. In yet another embodiment, creating the second Voice over Internet Protocol call further involves creating a Voice over Internet Protocol call to a plurality of recipient devices. An additional embodiment involves receiving, by the Voice over Internet Protocol switch, data specifying a particular time and date and postponing, by the Voice over Internet Protocol switch, the creation of the first Voice over Internet Protocol call and the second Voice over Internet Protocol call, until the particular time and date. Another embodiment involves determining that a first country code associated with the call-originating phone differs from a second country code associated with the at least one recipient device and placing at least one of the first call and the second call via international long distance.

Another related embodiment involves locating, by the Voice over Internet Protocol switch, at least one payment account associated with at least one of the call-originating phone and the at least one recipient device. A related embodiment further involves verifying, by the Voice over Internet Protocol switch that the at least one payment account contains sufficient funds to initiate the first Voice over Internet Protocol call and the second Voice over Internet Protocol call, and charging, by the Voice over Internet Protocol switch, the at least one payment account for the first Voice over Internet Protocol call and the second Voice over Internet Protocol call. An additional embodiment involves determining, by the Voice over Internet Protocol switch, that the at least one payment account does not contain sufficient funds to initiate the first Voice over Internet Protocol call and the second Voice over Internet Protocol call, prompting, by the Voice over Internet Protocol switch, a user of at least one of the call-originating phone and the at least one recipient device to provide a method of payment, receiving, by the Voice over Internet Protocol switch, the method of payment from the user, and charging, by the Voice over Internet Protocol switch, the received method of payment for the first Voice over Internet Protocol call and the second Voice over Internet Protocol call. Still another embodiment involves charging, by the Voice over Internet Protocol switch, the cost of the first Voice over Internet Protocol call and the second Voice over Internet Protocol call to a phone bill associated with the call-originating phone. A further embodiment involves prompting, by the Voice over Internet Protocol switch, a user of the call-originating phone to create a user account, receiving, by the Voice over Internet Protocol switch, an agreement or a decline to create the user account, and creating a user account using the data identifying the call-originating phone. Another embodiment includes prompting, by the Voice over Internet Protocol switch, the user to provide billing data, receiving, by the Voice over Internet Protocol switch, billing data from the user, and adding, by the Voice over Internet Protocol switch, the billing data to the user account. Yet another embodiment involves adding, by the Voice over Internet Protocol switch, a promotional credit having a value to the user account and deducting, by the Voice over Internet Protocol switch, the value of the promotional credit from a cost of the first Voice over Internet Protocol call and the second Voice over Internet Protocol call using the promotional credit.

Also disclosed is a system for telephone-initiated Voice over Internet Protocol communication. The system includes at least one call-originating phone, at least one recipient device, and at least one Voice over Internet Protocol switch configured to receive data identifying the call-originating phone and recipient device, to create a first Voice over Internet Protocol call to the call-originating phone, to create a second Voice over Internet Protocol call to the recipient device, and to combine the first call with the second call.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown. The novel features believed characteristic on the invention are set forth in the appended claims. The invention itself, however, as well as preferred modes of use, further objectives and advantages thereof, may be read in conjunction with the accompanying drawings, wherein:

FIG. 1 is a schematic diagram of one embodiment of the disclosed system.

FIG. 2 is a flow chart illustrating one embodiment of a method for telephone-initiated Voice over Internet Protocol communication.

FIG. 3 is a schematic diagram view of various texting commands used in one embodiment by a text-enabled phone to initiate VoIP calls, via the disclosed system.

FIG. 4A is a stepped process view providing situational examples of how embodiments of the system treat phone numbers from the text-enabled phone's Contact list by taking into account the selected SMS server FVN of the text-enabled phone initiating the phone call.

FIG. 4B is a flowchart illustrating how embodiments of the system decide whether to include the country code when sending the text command to the VoIP switch, based on the SMS switch selected by the text-enabled phone user.

FIG. 5A is a screen representation view of an embodiment of a user interface by means of which a Subscriber may initiate an account using a text-enabled device.

FIG. 5B is a screen representation view of an embodiment of a user interface showing the a main menu screen.

FIG. 5C is a screen representation view of an embodiment of a user interface showing a call screen.

FIG. 5D is a screen representation view of an embodiment of a user interface showing a create alias screen.

FIG. 5E is a screen representation view of an embodiment of the a user interface showing a create group screen.

FIG. 5F is a screen representation view of an embodiment of a user interface showing a payment processing screen.

FIG. 6A is a block diagram view of an exemplary embodiment of a system for initiating and completing long distance VoIP phone calls between one text enabled phone and any other type of phone virtually anywhere by the Caller's text-enabled phone sending an initiating text message to the Service's SMS server.

FIG. 6B is a block diagram view of an exemplary embodiment of a system enabling a subscriber to initiate and complete a long distance VoIP phone call from any type of phone (including non-text-enabled phones) to any other type of phone located virtually anywhere in the world.

FIG. 6C is a block diagram view of an exemplary embodiment of a system permitting a text-enabled phone to initiate and complete a toll free long distance VoIP phone call to a Subscribing entity using a text messaging service.

FIG. 6D is a block diagram view of an exemplary embodiment of the system enabling a Subscriber to initiate and complete a long distance VoIP phone call from any type of phone (including non-text-enabled phones) to any other type of phone virtually anywhere in the world.

FIG. 6E is a block diagram view of an exemplary embodiment of a system enabling a caller's text-enabled phone to initiate and complete long distance VoIP conference calls between multiple parties using a text message.

FIG. 6F is a block diagram view of an exemplary embodiment of a system providing for a Subscriber's text-enabled phone to initiate and complete a payment to (recharging of) the Subscriber's account using a text message.

FIG. 7 illustrates an embodiment of a method for processing payments for phone calls using text messaging.

FIG. 8A is a schematic diagram depicting a computing device and its communication infrastructure.

FIG. 8B is a schematic illustration of a web application platform.

### DETAILED DESCRIPTION OF SPECIFIC EMBODIMENTS

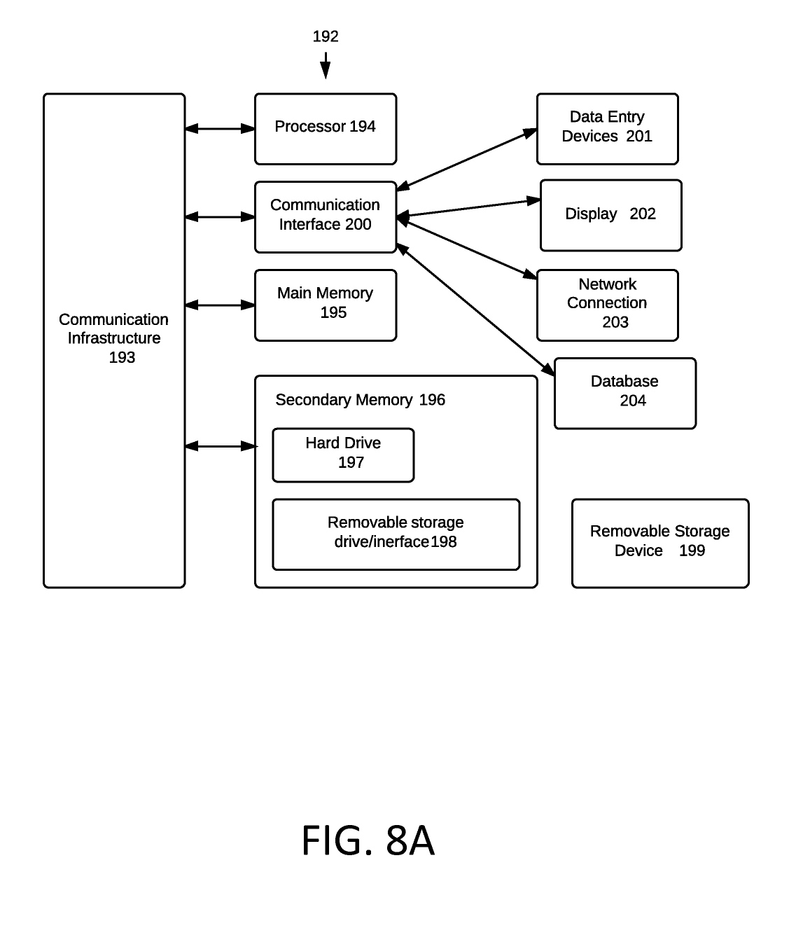

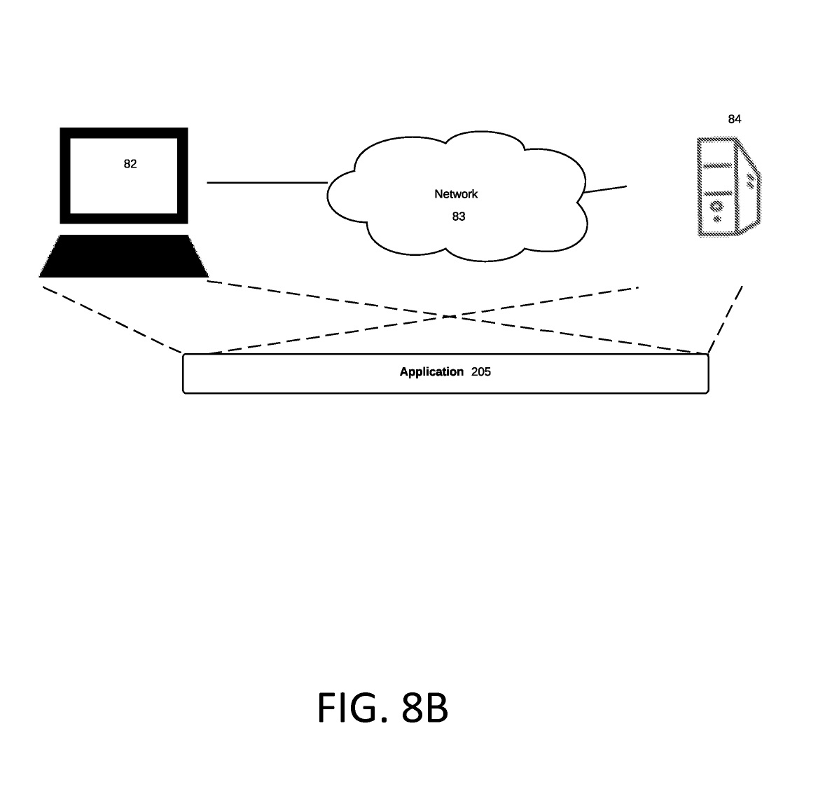

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 8A. The processor 194 may be a special purpose or a general-purpose processor device. As will be appreciated by persons skilled in the relevant art, the processor device 194 may also be a single processor in a multi-core/multiprocessor system, such system operating alone, or in a cluster of computing devices operating in a cluster or server farm. The processor 194 is connected to a communication infrastructure 193, for example, a bus, message queue, network, or multi-core message-passing scheme.

The computing device also includes a main memory 195, such as random access memory (RAM), and may also include a secondary memory 196. Secondary memory 196 may include, for example, a hard disk drive 197, a removable storage drive or interface 198, connected to a removable storage unit 199, or other similar means. As will be appreciated by persons skilled in the relevant art, a removable storage unit 199 includes a computer usable storage medium having stored therein computer software and/or data. Examples of additional means creating secondary memory 196 may include a program cartridge and cartridge interface (such as that found in video game devices), a removable memory chip (such as an EPROM, or PROM) and associated socket, and other removable storage units 199 and interfaces 198 which allow software and data to be transferred from the removable storage unit 199 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 200. The communications interface 200 allows software and data to be transferred between the computing device and external devices. The communications interface 200 may include a modem, a network interface (such as an Ethernet card), a communications port, a PCMCIA slot and card, or other means to couple the computing device to external devices. Software and data transferred via the communications interface 200 may be in the form of signals, which may be electronic, electromagnetic, optical, or other signals capable of being received by the communications interface 200. These signals may be provided to the communications interface 200 via wire or cable, fiber optics, a phone line, a cellular phone link, and radio frequency link or other communications channels. Other devices may be coupled to the computing device 192 via the communications interface 200. In some embodiments, a device or component is “coupled” to a computing device 192 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 192 may be coupled to a second computing device (not shown); for instance, a server may be coupled to a client device, as described below in greater detail.

The communications interface in the system embodiments discussed herein facilitates the coupling of the computing device with data entry devices 201, the device's display 202, and network connections, whether wired or wireless 203. In some embodiments, “data entry devices” 201 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

In some embodiments, a computing device's “display” 201 is a device coupled to the computing device, by means of which the computing device can display images. Display include without limitation monitors, screens, television devices, and projectors.

Computer programs (also called computer control logic) are stored in main memory 195 and/or secondary memory 196. Computer programs may also be received via the communications interface 200. Such computer programs, when executed, enable the processor device 194 to implement the system embodiments discussed below. Accordingly, such computer programs represent controllers of the system. Where embodiments are implemented using software, the software may be stored in a computer program product and loaded into the computing device using a removable storage drive or interface 198, a hard disk drive 197, or a communications interface 200.

The computing device may also store data in database 204 accessible to the device. A database 204 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 204, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 194, a communication infrastructure 193, at least a main memory 195, and usually a communications interface 200, not all devices will necessarily house these facilities separately. For instance, in some forms of computing devices as defined above, processing 194 and memory 195 could be distributed through the same hardware device, as in a neural net, and thus the communications infrastructure 193 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 8B. Web application platforms typically include at least one client device 82, which is an computing device as described above. The client device 82 connects via some form of network connection to a network 83, such as the Internet. The network 83 may be any arrangement that links together computing devices 82, 84, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 83 is at least one server 84, which is also an computing device as described above, or a set of computing devices that communicate with each other and work in concert by local or network connections. Of course, practitioners of ordinary skill in the relevant art will recognize that a web application can, and typically does, run on several servers 84 and a vast and continuously changing population of client devices 82. Computer programs on both the client device 82 and the server 84 configure both devices to perform the functions required of the web application 205. Web applications 205 can be designed so that the bulk of their processing tasks are accomplished by the server 84, as configured to perform those tasks by its web application program, or alternatively by the client device 82. Some web applications 205 are designed so that the client deice 82 solely displays content that is sent to it by the server 84, and the server 84 performs all of the processing, business logic, and data storage tasks. Such “thin client” web applications are sometimes referred to as “cloud” applications, because essentially all computing tasks are performed by a set of servers 84 and data centers visible to the client only as a single opaque entity, often represented on diagrams as a cloud.

Many computing devices, as defined herein, come equipped with a specialized program, known as a web browser, which enables them to act as a client device 82 at least for the purposes of receiving and displaying data output by the server 84 without any additional programming. Web browsers can also act as a platform to run so much of a web application as is being performed by the client device 82, and it is a common practice to write the portion of a web application calculated to run on the client device 82 to be operated entirely by a web browser. Such browser-executed programs are referred to herein as “client-side programs,” and frequently are loaded onto the browser from the server 84 at the same time as the other content the server 84 sends to the browser. However, it is also possible to write programs that do not run on web browsers but still cause an computing device to operate as a web application client 82. Thus, as a general matter, web applications 205 require some computer program configuration of both the client device (or devices) 82 and the server 84. The computer program that comprises the web application component on either computing device's system FIG. 8A configures that device's processor 194 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

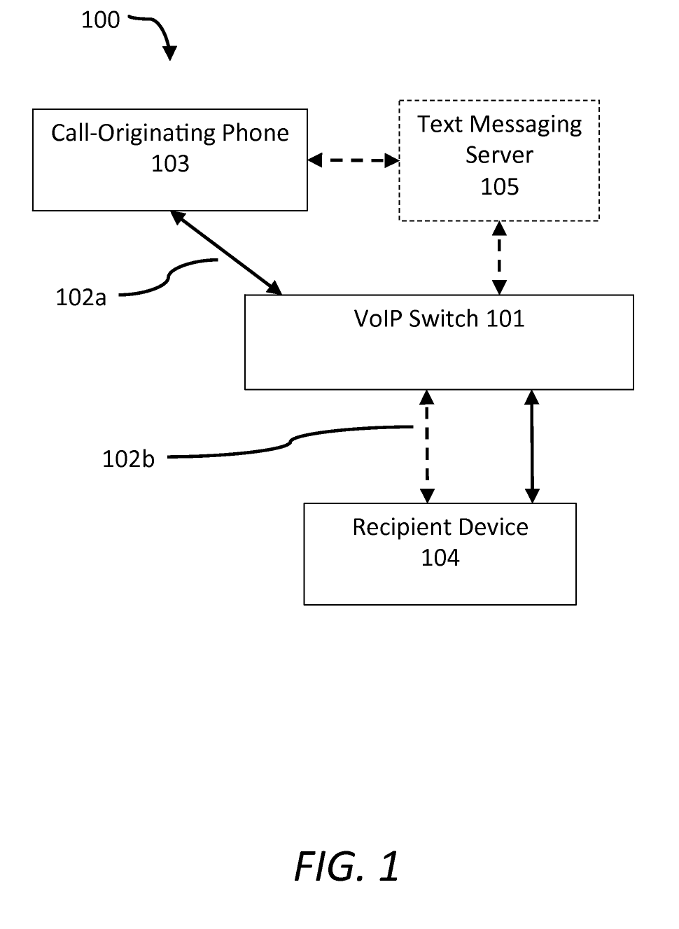

FIG. 1 depicts a system 100 for telephone-initiated Voice over Internet Protocol communication. As an overview, the system includes a VoIP switch 101. The VoIP switch 101 connects via a first publically switched telephone network (PSTN) 106C to a call-originating phone 103. The VoIP switch 101 also connects to a recipient device 104.

Referring to FIG. 1 in more detail, the system 100 includes a VoIP switch 101. In some embodiments, the VoIP switch 101 is a computing device 192 as disclosed above in reference to FIGS. 8A-B. In other embodiments, the VoIP switch 101 is a set of computing devices 192, as discussed above in reference to FIGS. 8A-B, working in concert; for example, the VoIP switch 101 may be a set of computing devices in a parallel computing arrangement. The VoIP switch 101 may be a set of computing devices 192 coordinating their efforts over a private network, such as a local network or a virtual private network (VPN). The VoIP switch 101 may be a set of computing devices 192 coordinating the efforts over a public network, such as the Internet. The division of tasks between computing devices 192 in such a set of computing devices 192 working in concert may be a parallel division of tasks or a temporal division of tasks; as an example, several computing devices 192 may be working in parallel on components of the same tasks at the same time, where as in other situations one computing device 192 may perform one task then send the results to a second computing device 192 to perform a second task. In one embodiment, the VoIP switch 101 is a server 84 as disclosed above in reference to FIG. 8B. The VoIP switch 101 may communicate with one or more additional servers 84. The VoIP switch 101 and the one or more additional servers 84 may coordinate their processing to emulate the activity of a single server 84 as described above in reference to FIG. 8B. The VoIP switch 101 and the one or more additional servers 84 may divide tasks up heterogeneously between devices. In some embodiments, the VoIP switch 101 functions as a client device 82 as disclosed above in reference to FIG. 8B.

The VoIP switch 101 is configured to connect and route VoIP calls by streaming data over a network from one electronic device to another electronic device. In some embodiments, VoIP calls stream data using a packet-based network communication protocol such as Internet protocol (IP). In one embodiment, packet-based network communication is the exchange of data packaged in formatted units over a network. The network may be a network 83 as defined above in reference to FIG. 8B.

In some embodiments, the VoIP switch 101 is configured to receive from the call originating device, data identifying the call originating device and recipient device, to create a first Voice over Internet Protocol call to the call originating device using the first publically switched telephone network, to create a second Voice over Internet Protocol call to the recipient device using the second publically switched telephone network, and to combine the first call with the second call, as set forth in further detail below. The VoIP switch 101 may be configured using one or more computer programs as defined above in reference to FIGS. 8A-B.

In some embodiments, the VoIP switch 101 communicates using one or more forwarding virtual numbers. In one embodiment, a forwarding virtual number is a phone number that forwards data to a computing device in communication with the VoIP switch 101. In some embodiments, information sent to the forwarding virtual number is received by a text messaging server 105 that processes text messages; the text messaging server 105 may forward data contained in text messages to the VoIP switch. The text messaging server 105 may receive data from the VoIP switch and transmit it as text messages. In some embodiments, the text messaging server 105 translates data from one protocol to another; for instance, the text messaging server 105 may be configured to insert the data from text messages, such as those sent in the simple messaging service (SMS) protocol, into packets to convey the data to the VoIP switch 101 using a packet-based protocol. Likewise, the text messaging server 105 may translate packet-based communications from the VoIP switch 101 into bit streams to transmit them as text messages.

The system 100 includes a first PSTN 102a. In one embodiment, a PSTN is set of one or more interconnected circuit-switched telephone networks. The networks may include any facility for communicatively connecting one electronic machine to another. A PSTN may include networks of telephone lines. A PSTN may include networks of fiber optic cables. A PSTN may include networks of microwave transmission links. A PSTN may include one or more cellular networks. A PSTN may include one or more communications satellites. A PSTN may include on or more undersea telephone cables. In some embodiments, the networks making up the PSTN are coordinated by switching centers that connect one machine to another via the networks. In some embodiments, the PSTN adheres to ITU-T: International Telephone Unit Telecommunication Standardization Sector. The PSTN may also follow protocols for universally unique telephone numbers developed in E.163, E.164, and later standards recommendations promulgated by the ITU-T. Any telephone device connected to a PSTN may be capable of communicating with any other telephone device connected to the same PSTN. A PSTN may be local, national, or global.

Some embodiments of the system 100 use non-packet-based network communication to exchange data. In one embodiment, non-packet-based network communication involves the transmission and reception of unformatted data, for instance in the form of bit streams. The non-packet-based network communication protocol may involve the use of circuit switching stations, such as the stations that connect telephone calls in a PSTN, as defined above. Telephone calls may be performed via non-packet-based network communication. Text messaging, as described in further detail below, may also be performed using non-packet-based network communication. As used below, a device is using non-packet-based communication if the message transmitted by the device itself is not transmitted via a packet-based network communication. For instance, if a phone sends an SMS message via a bit stream, and the SMS message is later converted by an intermediary device to a packet to transmit via a packet-based protocol, the phone is using non-packet-based network communication.

The system 100 includes a call-originating phone 103. The call-originating phone may be a telephone. The call-originating phone 103 may be a “land line” phone that communicates via wires. The call-originating phone 103 may be a cellular phone. The call-originating phone may be a digital phone. In some embodiments, the call-originating phone 103 is a text-enabled phone. In one embodiment, a text-enabled phone is a phone capable of sending text messages to other devices. The text-enabled phone may also be capable of receiving text messages from other devices.

In one embodiment, a text message is an electronic message sent from one device to another over a telephone network, such as a PSTN 102a as described above. A text message may contain alphanumeric data. In some embodiments, text messages are sent via the short messaging system (SMS) protocol. In some embodiments, text messages do not hit the PSTN carrier switch, but rather stay internal, for instance through other cell traffic carriers (usually fellow domestic carriers) with which a cell phone carrier shares cellular network traffic through the carrier's cellular network to its SMS texting server, where the call-originating phone 103 is a cell phone. As a result, text messaging may provide a relatively low-cost telecommunications tool. The primary (default) SMS server may be the cell phone carrier's SMS server. SMS messaging has become a ubiquitous method for low-cost domestic communications worldwide, in part because it does not require the packet-based communication capabilities necessary to use an Internet connection. In some embodiments, text messages are also relayed via “gateway” text messaging services internationally through the Internet by using a SMS server gateway.

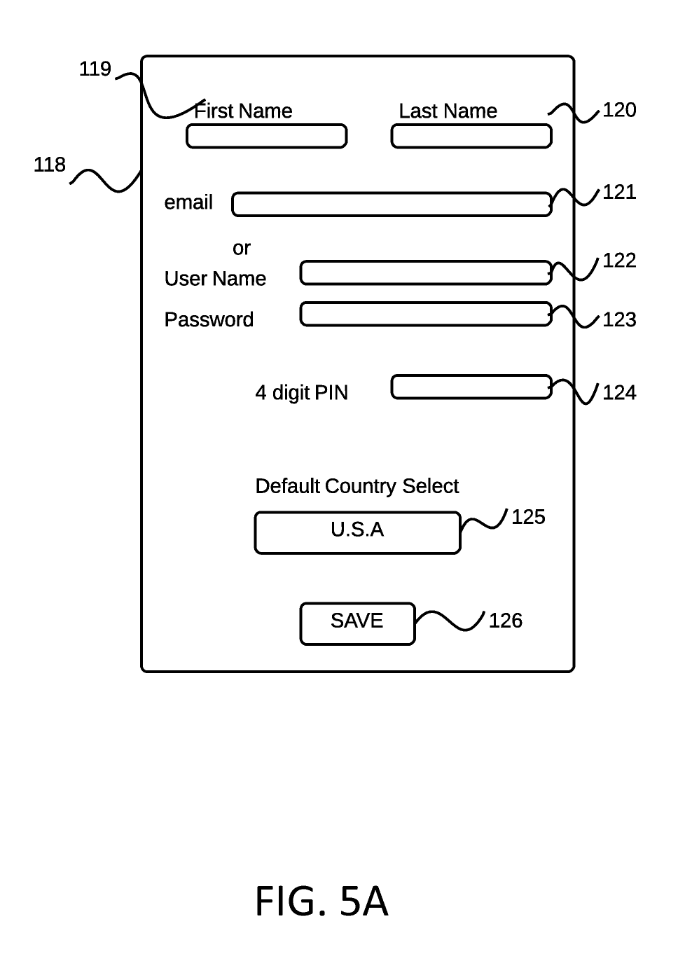

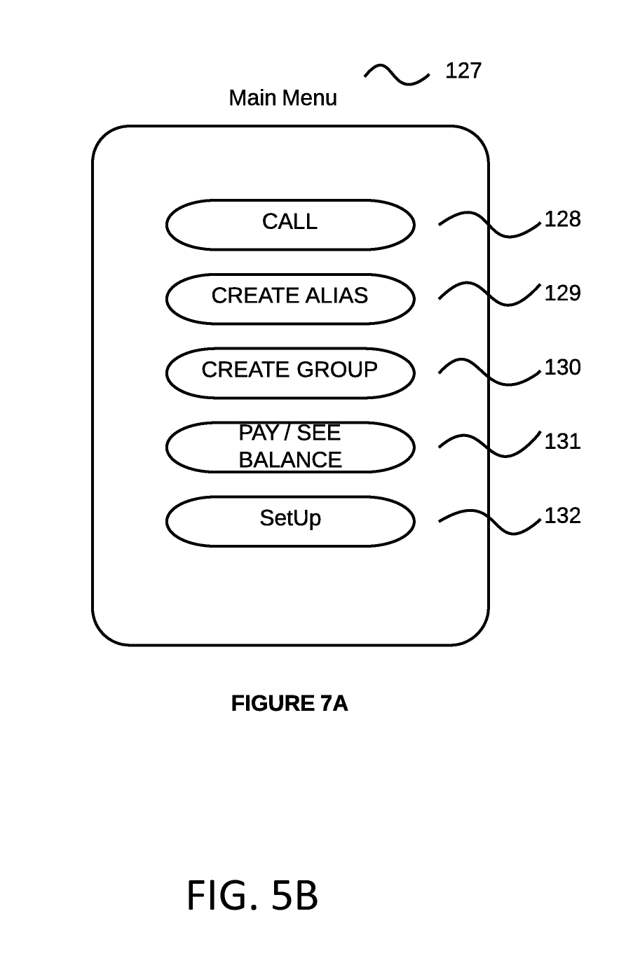

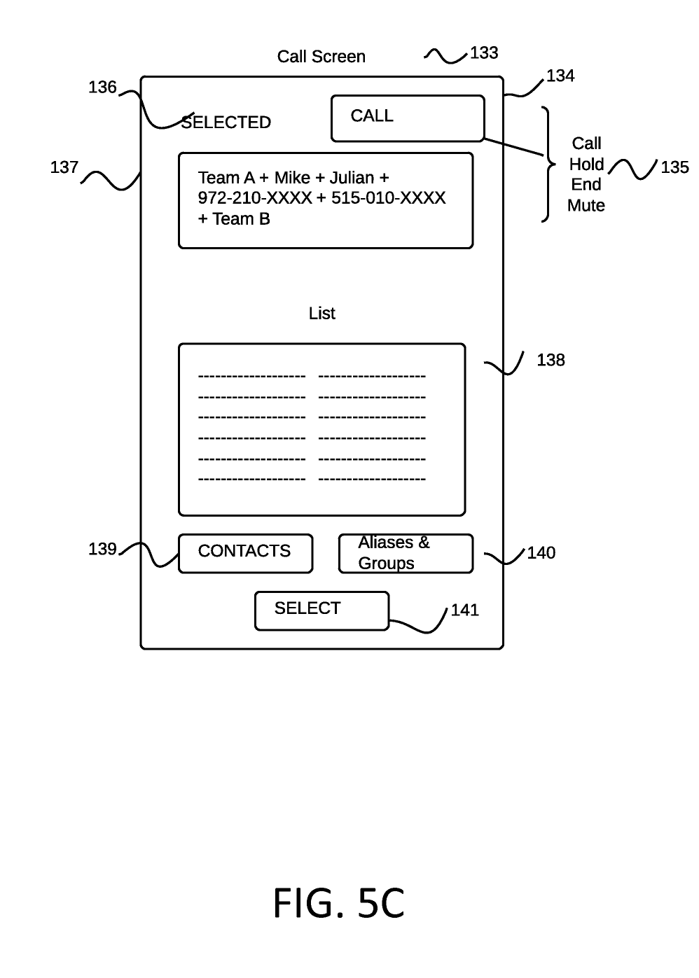

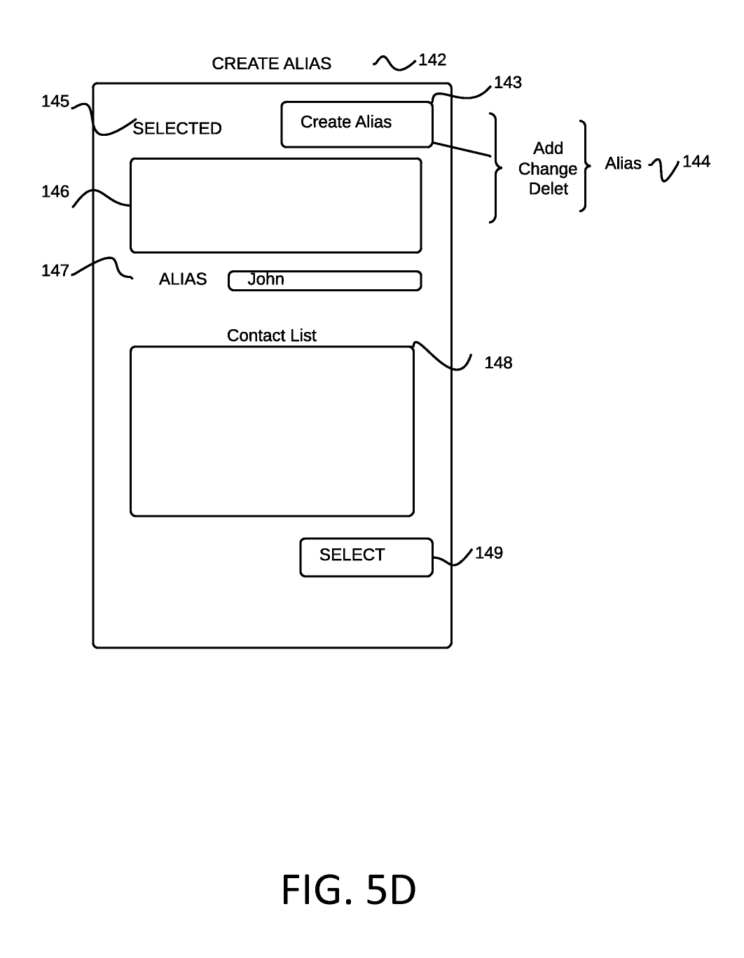

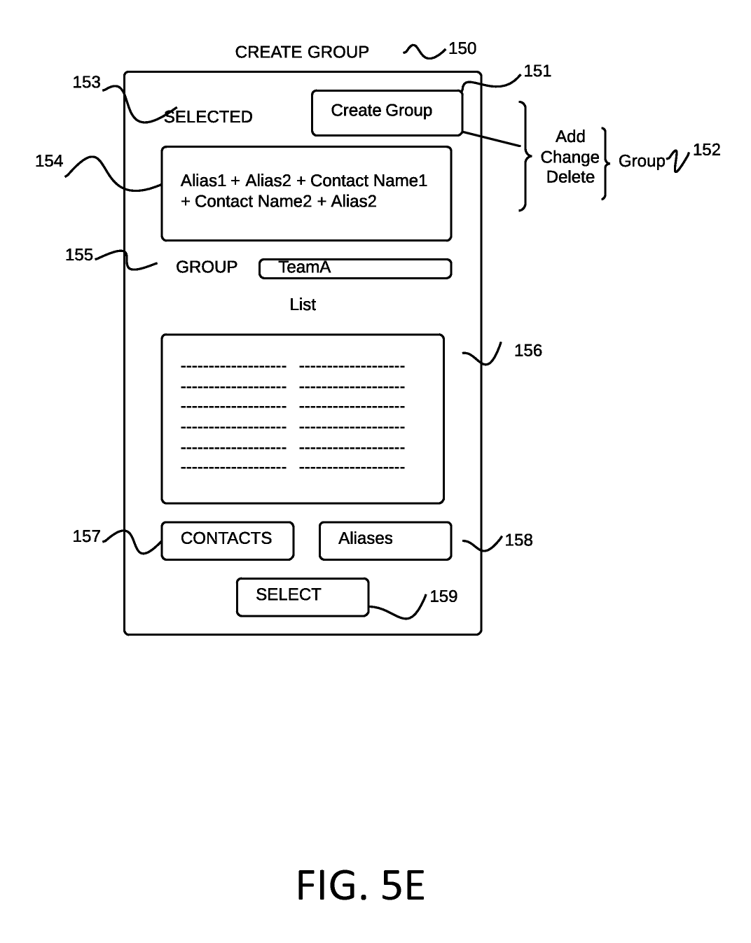

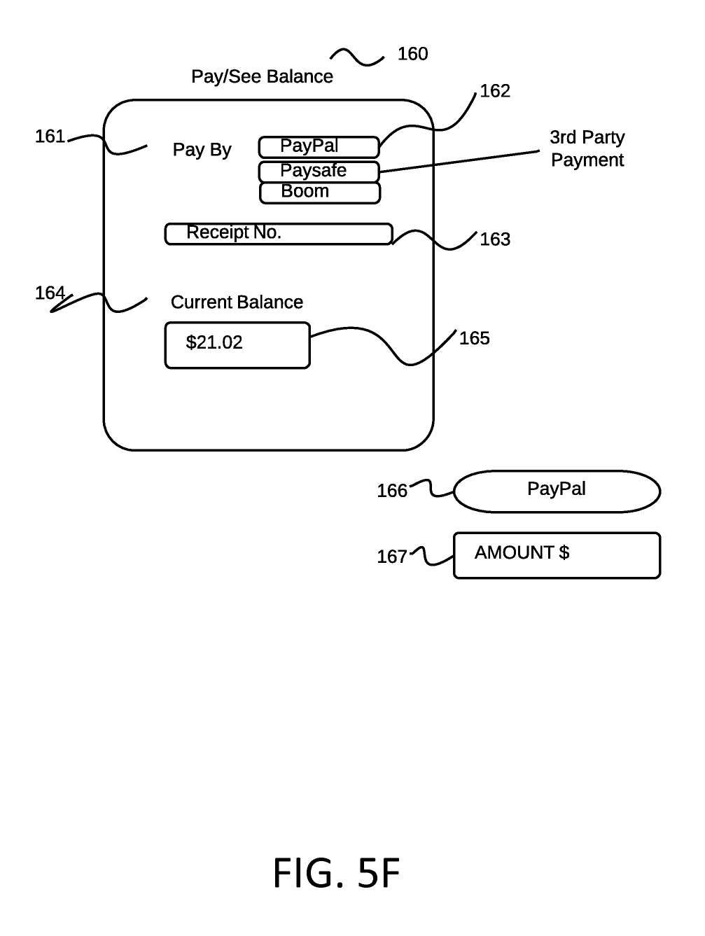

In some embodiments, the system 100 also includes a user interface (not shown). The user interface may be provided via an application installed on the call-originating phone 103. The user interface may be provided via a web browser. In some embodiments, the user interface has elements as disclosed below in reference to FIGS. 5A-F.

The VoIP switch 101 also connects to a recipient device 104. In some embodiments, the recipient device 104 is a telephone. The recipient device 104 may be capable of sending text messages. The recipient device 104 may be a cellular phone. The recipient device 104 may be a smartphone. In other embodiments, the recipient device 104 is a computing device 192 as described above in reference to FIGS. 8A-B. The VoIP switch 101 may connect to the recipient device 104 via a network, such as the network 83 described above in reference to FIG. 8B; for instance, the VoIP switch 101 may communicate with the recipient device 104 directly via VoIP. In other embodiments, the VoIP switch 101 connects to the recipient device 104 via a second PSTN 102b. The second PSTN 102b may be the same as the first PSTN 106C.

In some embodiments, the VoIP switch communicates with one or more third-party payment processors to process payments for calls as set forth in more detail below. For example, SMS communication may facilitate money transfers via third-party payment processors such as the PAYPAL service offered by Paypal Inc., of San Jose, Calif., wherein the user enters his cell phone number into his account profile with the third-party payment processor. A further example of third party payment processors is represented by the BOOM service offered by Boom! Payments, LLC of Los Angeles, Calif., and the PAYSAFE service offered by paysafecard.com Wertkarten AG Corporation of Vienna, Austria. These services rely on an established international retail network, and use virtual cards or accounts loaded with cash and having associated personal identification numbers (PIN) that, when provided to a merchant, allow the merchant to process a payment using the PIN. To transfer money, one store on either geographic end of the money sender and the money receiver is required. The payment sender gives Retailer A funds to send by electronic funds transfer to a given party in another city (or country). The “receiver” of the money (the text message with the receipt number for the transaction) goes to Retailer B, which is also in the “network” of retailers carrying that service and has received a funds transfer for the transaction. These services also function if Retailer A or B is a website.

In some embodiments, a phone carrier sets up “short codes,” using 4 to 6 numeric digits to which the cell phone's owner can text a “keyword” to purchase a service or “item,” such as a ringtone, donation, or digital purchase. The carrier may charge the cell phone owner's cell phone account for the service, and pay the service or item provider, less a service fee for the payment processing. In other embodiments, text messaging is used in programmed communications. Text messages in some embodiments may also be used by third-party payment processors to process payments. The owner of the third-party payment processor account may send a text to an SMS server operated by the third-party payment processor, which receives the message. The SMS server may be configured to parse the text message for commands regarding processing of payments; for instance, the “message” section of the sent text may follow a simple command structure such as “send 10.99 to 214-203-1212” (or a short form thereof), wherein the “send” and “to” are mapped by the payment processor's SMS server to commands initiating a transfer of funds and used as tokens to find message sections corresponding to the funds to send and the destination account to which the funds should be sent. The SMS server may further store data in its memory mapping the destination identifier to an account with the third party payment processor.

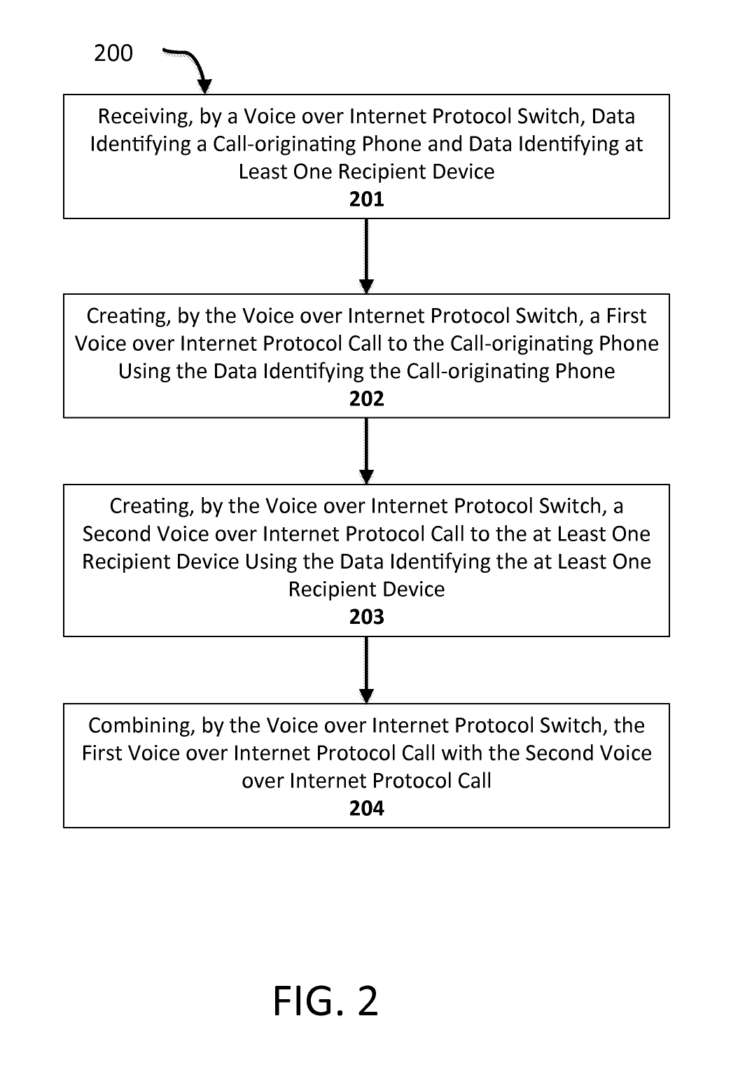

FIG. 2 illustrates some embodiments of a method 200 for initiating Voice over Internet Protocol communication. The method 200 includes receiving, by a Voice over Internet Protocol switch, data identifying a call-originating phone and data identifying at least one recipient device (201). The method 200 includes creating, by the Voice over Internet Protocol switch, a first Voice over Internet Protocol call to the call-originating phone using the data identifying the call-originating phone (202). The method 200 includes creating, by the Voice over Internet Protocol switch, a second Voice over Internet Protocol call to the at least one recipient device using the data identifying the at least one recipient device (203). The method 200 includes combining, by the Voice over Internet Protocol switch, the first call with the second call (204).

Referring to FIG. 2 in greater detail, and by reference to FIG. 1, the VoIP switch 101 receives data identifying a call-originating phone and data identifying at least one recipient device (201). In some embodiments, the VoIP switch 101 receives the data identifying the call-originating phone 103 and the data identifying at least one recipient device 104 from the call-originating phone 103. In other embodiments, the VoIP switch 101 receives the data identifying the call-originating phone 103 and the data identifying at least one recipient device 104 from a computing device (not shown); for instance, the user of the call-originating phone 103 may send the data using another computing device. The data identifying the call-originating phone 103 may include a phone number. The phone number may be a local phone number. The phone number may be an international phone number. In some embodiments, the VoIP switch 101 determines the local area information associated with the phone number. For instance, the VoIP switch 101 may determine the country within which the number identifying the call-originating phone 103 was issued; the number of digits in the phone number may determine the country. In other embodiments, the data may include a first country within which call-originating phone 103 is located. Where the call-originating phone 103 contacts the VoIP switch by a forwarding virtual number, the local area information concerning that number may enable the VoIP switch to determine the local area information associated with the call-originating phone 103; for instance, if the call-originating phone 103 contacted the forwarding virtual number local to a particular country using local rather than international contacting protocols, the VoIP switch 101 may determine that the call originating phone 103 is local to the country in which the forwarding virtual number is located. The data identifying the call-originating phone may include an identifier associated with a user account created on the VoIP switch 101 as set forth in further detail below. The data identifying the call-originating phone 103 may include data identifying a first person or entity associated with the call-originating phone.

The data identifying the at least one recipient device 104 may include one or more telephone numbers; for instance, where the at least one recipient device 104 is a telephone, the data identifying the recipient device 104 may be a telephone number associated with the telephone. The data identifying the recipient device 104 may include the identities of one or more recipient devices 104 in at least one VoIP system. The at least one VoIP system may include the same VoIP system operated by the VoIP switch 101. The at least one VoIP system may include a VoIP system operated by a different party. In some embodiments, the data identifying the recipient device 104 includes at least one IP address. The data identifying the recipient device 104 includes at least one a device identifier in other embodiments. The data identifying the recipient device 104 may include one or more identifiers associated with one or more user accounts registered with the VoIP switch 101, as set forth in more detail below. The data identifying the at least one recipient device 104 may be the identifier of one or more contacts created by the user of the call-originating phone 103, as set forth in more detail below; for instance, the identifier of the recipient device 104 may be an alias or a group identifier as set forth in further detail below. The data identifying the at least one recipient device 104 may include a second country within which the at least one recipient device is located. The data identifying the at least one recipient device 104 may include data identifying at least one person or entity associated with the recipient device.

In some embodiments, the call-originating phone 103 sends the data in a non-packet-based communication form. In one embodiment, the call-originating phone 103 sends the data via a text message. In some embodiments, the user enters a text message by following syntax enabling the VoIP switch 101 to parse the text message to determine the data. The text in the text message may be delimited by character data that divides the text into data fields; the character data may be a single character. The character data may be a string of characters. For instance, the text message may be delineated by spaces, such that a string of text in the text message preceding the first space identifies the call-originating phone 103 while the string of text following the first space represents the at least oned recipient device 104; where there is more than one recipient device, there may be further delimiters to distinguish each separate recipient device 104. In some embodiments, the text message contains additional items of data; the additional items may be separated from the rest of the message by further delimiters. The identity of the call-originating phone 103 may be contained in a field identifying the sending device according to the text messaging protocol; for instance, the “source_addr” field in an SMS message may contain the phone number associated with the call-originating phone 103.

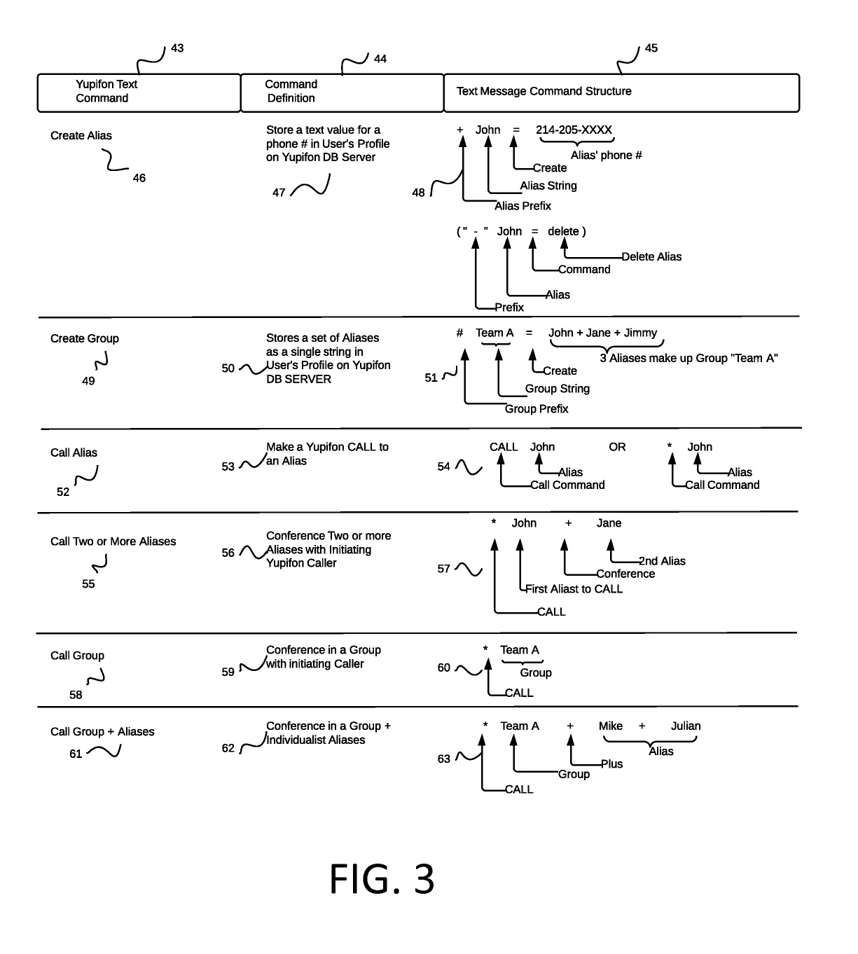

In some embodiments, the text message contains text identifying the category of command the text message is conveying to the VoIP switch 101. For example, the VoIP switch 101 may be configured to recognize a prefix indicating the nature of the command conveyed in the text message; one prefix may indicate that the text message is a command to initiate a call, and identifies the call-originating phone 103 and the at least one recipient device 104. Non-limiting examples of additional commands that may be conveyed by text messages are illustrated in FIG. 3. As one example, the syntax 54 for a command 52 to make a call to an individual recipient device 104, as identified by item 53, may begin with the prefix “CALL” followed by data identifying the recipient device. The syntax 54 may use the special character “*” as a prefix. As another example, the syntax 57 for a command 55 to create a conference call, as identified by item 56, and as set forth in greater detail below, may identify the command using the special character “*” as a prefix, and follow the command with a list of identifiers of recipient devices 104, in this example delimited by the “+” character. The syntax 60 for the command 58 to call a group, as defined in item 59 and described in further detail below, may identify the command using the special character “*” as a prefix, followed by an identifier of the group. The syntax 63 for a command 61 to call both a group and one or more individual recipient devices 104, as defined by item 62 and set forth in further detail below, may identify the command using the special character “*” as a prefix, followed by the identifier of one or more groups and the identifiers of one or more additional recipient devices 104. The syntax 48 for a command 46 to create a new alias, as defined in item 47 and set forth in further detail below, may use the special character “+” as a prefix, followed by an alias name, such as “John” and an identifier of the recipient device 104 associated with the alias, in this case a phone number, with the alias name and recipient device 104 identifier separated by the special character “=” as a further delimiter or operator. The syntax 51 for a command 49 to create a new group, as defined by item 50 and as set forth in further detail below, may use the special character “#” as a prefix, followed by the group name, separated by the special character “=” from a list of recipient device 104 identifiers, the list being delimited by the special character “+” to separate the identifiers. The preceding examples of command syntax are not intended to limit command syntax used in conjunction with the disclosed system and method. Persons skilled in the art will be aware of many techniques for delimiting text or otherwise differentiating fields within text, including the use of self-describing formats such as Extensible Markup Language (XML) and the use of fixed-field text formats.

In some embodiments of the method 200, the non-packet-based network communication is a phone call placed using the first publically switched telephone network. In some embodiments, the call-originating phone 103 calls a forwarding virtual number operated by the system 100, via the first PSTN, which is connected to the VoIP switch 101. The initial call may contain the data identifying the call-originating phone as a call-back number. In some embodiments, the user of the call-originating phone enters data by manual entry upon the connecting to the VoIP switch 101; for instance, the user may enter data identifying one or more recipient devices 104, such as a phone number.

In other embodiments, the VoIP switch 101 maintains, in its memory, an account associated with the phone number of the call-originating phone 103. The account may map the forwarding virtual number to one or more identifiers associated with recipient devices 104; thus, when a particular call-originating phone 103 places a call to a particular forwarding virtual number, the VoIP switch 101 uses the map to select the identifier of the one or more recipient devices 104 associated with that forwarding virtual number for that call-originating phone 103. Where the map associates a single recipient device 104 with the forwarding virtual number, the VoIP switch may proceed to create a two-device phone call as set forth in further detail below. Where the map associates multiple recipient devices 104 with the forwarding virtual number, the VoIP switch 101 may proceed to create a multiple-device phone call, or conference call, as set forth in further detail below. The VoIP switch 101 may operate multiple forwarding virtual numbers, such that the user of each call-originating phone 103 is able to associate a forwarding virtual number with each recipient device 104 or group of recipient devices 104 that the user wishes to call. The VoIP switch 101 may create the map associating a particular forwarding virtual number with a particular set of one or more recipient devices 104 for a particular call-originating device 103 upon the user of the call-originating device creating a contact associated with the set of recipient devices 104 as set forth in further detail below.

The VoIP switch 100 creates a first Voice over Internet Protocol call to the call-originating phone using the first PSTN (202). In some embodiments, the VoIP switch 101 places a VoIP call to the call-originating phone 103. For instance, where the call-originating phone 103 initiated the process by transmitting a text message to the VoIP switch, the VoIP switch 101 may call the call-originating phone back. Where the call-originating phone 103 initiating the process by placing a phone call to the VoIP switch 101, the VoIP switch 101 may exit the call and place a new call to the call-originating phone 103. In other embodiments, where the call-originating phone 103 calls the VoIP switch 101 via a forwarding virtual number, the VoIP switch 101 creates the call to the call-originating phone 103 by responding to the initial call, which it does not exit unless prompted by the user of the call-originating phone 103.

The VoIP switch 101 creates a second Voice over Internet Protocol call to the recipient device 104 (203). In some embodiments, the VoIP switch 100 creates the second call by creating a VoIP session with the at least one recipient device 104 using a packet-based network communication protocol. For instance, where the recipient device 104 is a computing device 192 as described above in reference to FIGS. 8A-B, the VoIP switch 101 may initiate packet-based communication with a VoIP client operating on the recipient device 104, pursuant to the VoIP. In other embodiments, the VoIP switch 101 creates the second call by creating a telephone call using a second publically switched telephone network 102b to the recipient device 104; for example, where the recipient device 104 is a telephone, the VoIP switch 101 may create a VoIP call to a PSTN switch on the second PSTN 102b, so that the second PSTN 102b streams call to and from the second recipient device 104.

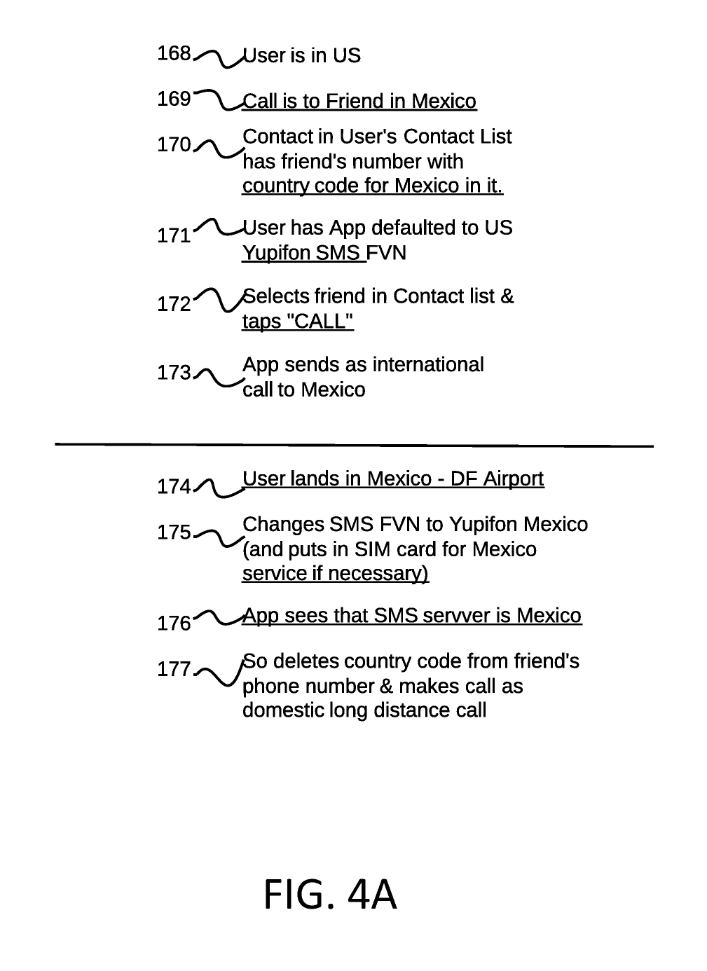

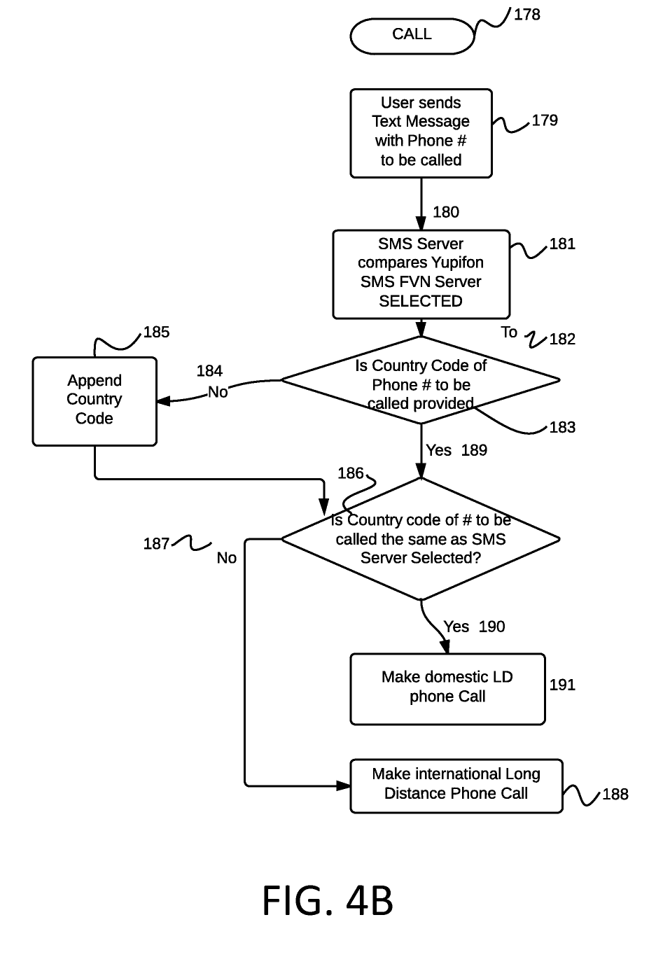

In some embodiments, as further illustrated by FIG. 4A-B, the VoIP switch 101 compares the data identifying each recipient device 104 to the forwarding virtual number contacted by the call-originating phone 103, and determines whether to include a country code in the number used to create the second call. For example, if a contact, alias or member of a group is within the country of service of the SMS server being used, then the VoIP switch 101 may determine that the country code should not be included in the number used to call the recipient. Likewise if a contact, alias or member of a group being called is outside the country of service from which the call(s) are being made, then the VoIP switch 101 may determine that the country code should be included in the number used to create the second call. In some embodiments, when the country code is included in the number and the VoIP switch 101 determines that the country code should not be used, the VoIP switch 101 removes the country code from the number. In other embodiments, where the country code is not included in the number, and the VoIP switch 101 has determined that the country code should be included in the number, the VoIP switch 101 appends the country code to the number.

In some embodiments, the VoIP switch 101 receives a first country code with which the call-originating phone 103 is associated, detects that the second telephone number associated with the at least one recipient device 104 does not include a country code, retrieves a first country code associated with the second telephone number, and automatically appends the first country code to the second telephone number. The VoIP switch may receive the first country code in the data identifying the call-originating phone; for instance, the first country code may be obtained automatically from a Short Message Service server over which the user telephone and the at least one destination number data were transmitted to the VoIP switch 101. The second country code may be retrieved from a linked database of country codes, other information associated with the at least one recipient device 104. The at least a second country code may be derived automatically, by the VoIP switch 101, using syntax analysis of the received data and the linked database of information. In some embodiments, the VoIP switch 101 determines that a first country code associated with the call-originating phone 103 differs from a second country code 104 associated with the at least one recipient device, and places at least one of the first call and the second call via international long distance; in other words, the VoIP switch 101 may place the first call, the second call, or both via international long distance.

In other embodiments, the above steps are performed by an application operating on the call-originating phone 103. By way of a non-limiting example, if the user is in the United States 168, and makes a call and the call is to a friend in Mexico 169, the contact in the user's contact list may have the friend's number with country code for Mexico in it 170. Continuing the example the user texts to an SMS forwarding virtual number in the United States 171, and sends a command to place an international call 172 the application sends as international call to Mexico 173. Further continuing the example, if the user Lands in Mexico—DF Airport 174 the application changes the SMS forwarding virtual number to a Mexican number, 175 and the application determines that the that SMS server is in Mexico 176, deleting the country code from the phone number and makes the call as domestic long distance call 177.

FIG. 4B is a flowchart illustrating the same example of a process by which an application will decide whether to include the country code when sending the text command to the VoIP switch 101, based on the SMS server selected by the user of the call-originating device 103. A call 178 may be initiated by the caller sending a text message identifying the recipient device 104 the user is attempting to contact 179, which may be sent 180 to the service's text messaging server 182 which compares the forwarding virtual number that the text message came in on to the country code of the phone number of the desired recipient device 104. Continuing the example, a decision point may be executed in which the application determines if the country code of the phone number to be called is provided 183, as described above; if it is not 184, then the application may append the country code 185 and execute the next decision point of determining if the country code of the number to be called is the same as the SMS Server selected 186. Further continuing the example, if the country code is not the same 187, then the application may make an international by appending the country code 188. Still continuing the example, if in determining if the country code of the phone number to be called has been provided 184 the application finds that it has been 189, then the application may continue straight on to determining if the country code of the number to be called is the same as the SMS Server selected 186; at this decision point if the application determines 190 it is the same, the application may make a domestic long distance phone call by using the phone number without a country code. 191. Still continuing the example, if the application determines that the country codes are not the same 187, the application may make an international long distance phone call 188.

The VoIP switch 101 combines the first call with the second call (204). In some embodiments, the VoIP switch 101 patches, or merges the first call to the second call. Where there is more than one recipient device 104, the second call may consist of several separate component calls to different recipient devices 104; VoIP switch 101 may then effectively merge several different VoIP calls together to produce the completed call. In some embodiments, the Voice over Internet Protocol switch 101 receives data specifying a particular time and date, and postpones the creation of the first Voice over Internet Protocol call and the second Voice over Internet Protocol call until the particular time and date. The time and date may be received in the data identifying the call-originating phone 103 or the data identifying at least one recipient device 104; the time and date may be sent separately from any device, including the call-originating phone 103 or the at least one recipient device 104.

In some embodiments, the VoIP switch 101 receives, from a user of the call-originating phone 103, an instruction providing account information. The user may transmit the instruction to the VoIP switch 101 using the call-originating phone 103; for instance, the user may transmit the instruction using text messaging as described above in reference to FIG. 2. The user may transmit the instruction by entering it on a user interface on the call-originating phone 103; the user interface may be a web browser rendering of a web page provided by the VoIP switch 101. The user interface may be an application designed to communicate with the VoIP switch 101. In another embodiment, the user enters the instruction via a different device from the call-originating phone 103; for instance, the user may enter the instruction using a computing device. The user may enter the instruction via the computing device using any user interface described above in regard to entering the instruction on the call-originating phone 103. The VoIP switch 101 may save the account information entered by the user instruction in memory accessible to the VoIP switch 101; for instance, the VoIP switch may save the account information in a database in communication with the VoIP switch 101.

The account information may create a user account. The account information may create a new contact or alias for the user; for instance, the user may enter information necessary to complete a call to a recipient device 104, and an identifier to associate with that information. The identifier may be a name, or similar simplified datum easier for a user to remember than the original contact information. The contact created may for a group; for instance, the user may enter information identifying a set of recipient devices 104 and an identifier for the set taken together, such that calling the identifier will cause the VoIP switch 101 to call the entire set; the user may enter some recipient device 104 information that is new. The user may enter an identifier corresponding to recipient device 104 information that was previously stored as a contact. In some embodiments, the VoIP switch 101 maps each newly entered contact or alias to a distinct forwarding virtual number as described above in reference to FIG. 2.

In some embodiments, the account information includes payment information. For instance the account information may include a user account with a third-party payment processor that the VoIP switch 101 may bill for calls made by the user. The account information may include a user account with a financial institution; for instance, the account information may include credit card billing information for the user. The account information may include bank account billing information for the user, such as a bank account number or a routing number.

In some embodiments, the VoIP switch 101 calculates the price of the combined call, determines a payment account associated with the call-originating phone 104, and processes a payment for the price using the determined account. The VoIP switch may determine the price according to any stored or derived information setting prices for calls; the price may be determined by a billing rate per unit of time, such as a price per minute. The price may be determined as a flat rate for calls placed over a certain period of time. In some embodiments, the payment account is stored in memory accessible to the VoIP switch 101; for instance, the user may have entered the payment account as described above in reference to FIG. 2. In other embodiments, the payment account is an account administered by the operator of the VoIP switch; the account may be a prepaid account to which the user can add value prior to making phone calls. The account may be a credit account which periodically bills the user for accrued charges. In some embodiments, the payment account is the account the user has with the carrier for the call-originating phone 103; the VoIP switch 101 may cause the cost of the combined call to be added to the phone bill the user receives for the use of the call-originating phone 103. The account may be an account with a third-party processor.

In another embodiment, the VoIP switch calculates the price of the combined call, determines an account associated with the at least one recipient device 104, and processes a payment for the price using the determined account. The calculation of the price may proceed as described above in reference to FIG. 2. In some embodiments, the VoIP switch 101 locates at least one payment account associated with at least one of the call-originating phone 103 and the at least one recipient device 104, verifies that the at least one payment account contains sufficient funds to initiate the first Voice over Internet Protocol call and the second Voice over Internet Protocol call, and charges the at least one payment account for the first Voice over Internet Protocol call and the second Voice over Internet Protocol call. The payment account may be associated with the call-originating phone 103, with the at least one recipient device 104, or with both devices. The VoIP switch 101 may locate the at least one payment account by querying a linked database of user information.

In some embodiments, the VoIP switch 101 determines that the at least one payment account contains sufficient funds to pay for the first Voice over Internet Protocol call and the second Voice over Internet Protocol call, and the VoIP switch charges the at least one payment account. The VoIP switch 101 may determine that the at least one payment account does not contain sufficient funds to initiate the first Voice over Internet Protocol call and the second Voice over Internet Protocol call. The VoIP switch 101 may prompt a user of at least one of the call-originating phone and the at least one recipient device to provide a method of payment; the VoIP switch 101 may prompt a user of the call-originating phone 103, the at least one recipient device 104, or both. The prompt may be conveyed using any form of communication that may be initiated by the VoIP switch 104, including without limitation web applications, electronic mail, and non-packet-based communications such as text messages and PSTN calls. In some embodiments, the VoIP switch 101 receives the method of payment from the user; the method of payment may include an account number, such as a checking account number with its routing number, or a credit card number. The method of payment may be conveyed by any device used by the user, including the call-originating device 103, the at least one recipient device 104, or an additional computing device (not shown). The VoIP switch 101 may charge the received method of payment for the first Voice over Internet Protocol call and the second Voice over Internet Protocol call. The VoIP switch 101 may suspend one or more of the calls until payment is processed. In other embodiments, the VoIP switch 101 charges the cost of the first Voice over Internet Protocol call and the second Voice over Internet Protocol call to a phone bill associated with the call-originating phone.

In some embodiments, the VoIP switch 101 prompts a user of the call-originating phone to create a user account, receives an agreement to create the user account, and creates a user account using the data identifying the call-originating phone. The VoIP switch 101 may further prompt the user to provide billing data; when the VoIP switch receives the billing data from the user, the VoIP switch 101 may add the billing data to the user account. In some embodiments, billing data and authorization includes credit card information and authorization, third party platform information and payment authorization, and bank account information and charge authorization. The VoIP switch may add a promotional credit having a value to the user account and deduct the value of the promotional credit from a cost of the first Voice over Internet Protocol call and the second Voice over Internet Protocol call using the promotional credit.

The user of a recipient device 104 may establish an account with the proprietor of the VoIP switch 101 whereby the user of the recipient device 104 compensates the proprietor of the VoIP switch 101 for the cost of calls placed via the VoIP switch to the recipient device 104; in some embodiments, the arrangement functions similarly to a toll-free number provided by the VoIP switch 101. In some embodiments, the user of the recipient device 104 pays a monthly fee to cover the price of incoming calls. In other embodiments, the user of the recipient device 104 pays a bill proportionate to the volume of calls the recipient device 104 receives via the VoIP switch; the user may pay a fee per minute for the calls, as an example. Payment may be processed according to any method described above in reference to FIG. 2.

In some embodiments, the user may perform the method steps described above via a user interface. FIGS. 5A-E illustrate some exemplary user interface screens by means of which a user of the call-originating phone 103 may engage in the steps of the method as described above in reference to FIG. 2. FIG. 5A is a screen representation view of an embodiment of the user interface showing the ACCOUNT SET UP screen for an App created to ease the use of the present invention to initiate and complete long distance phone calls and perform other commands to set up a subscriber's account by sending text messages using various commands. In some embodiments, this screen entry layout on a smart phone 118 makes setting up the subscriber's service account easier, for instance by providing for the entry of the subscriber's first name 119 and last name 120, supplying an email address 121 or a user name 122, a password 123 for whichever login in avenue is selected, the entry of a 4 digit PIN 124, default country selection 125, and a “SAVE” button 126 to instruct the VoIP switch to save the account data thus entered.

FIG. 5B is a screen representation view of an embodiment of a user interface showing a MAIN MENU screen for an application created to ease the use of system 100 to initiate and complete long distance phone calls, create aliases and Groups, and perform other commands, such as recharging the user account by sending text messages using various commands. The Main Menu 127 has function selectors for CALL 128, CREATE ALIAS 129, CREATE GROUP 130, PAY/SEE BALANCE 131, and SET UP 132, which may select the set up screen as described in FIG. 5A.

FIG. 5C is a screen representation view of an embodiment of a user interface showing the CALL SCREEN for an application created to ease the use of the system 100 to initiate and complete long distance phone calls and conference calls. In this embodiment, the screen layout 134 of the Call Screen 133 allows the caller to select 141 Contacts 139 from the caller's Contact List or from the caller's Aliases and Groups 140 and to then see them displayed in a list 138 from which to select and display them 137 to be called by sending a text command. The caller may then also place the call on hold, mute, end and so forth 135 as with any standard phone call. The advantage of using the application in some embodiments is that the caller need not know the command to text to the SMS server associated with the system 100, but rather may simply select the human readable selection on the Call Screen 133.

FIG. 5D is a screen representation view of an embodiment of a user interface showing the CREATE ALIAS screen for an application created to ease the use of the system 100 in assigning a text name to reference and “dial” the number of a recipient device 104, such as “Mom” or “Home office,” that will be texted by the caller and looked up by the VoIP switch 101 to dial the recipient device 104 number. In some embodiments, on the Create Alias Screen 142 using the subscriber's Contact List format, the user can create text aliases for recipient device 104 identifiers 143 to display 146 the selected 145 and alias 147 add, change and delete Aliases 144 by selecting identifiers 149 that have been previously called by having been texted directly, but lacking a Contact Name 148.

FIG. 5E is a screen representation view of an embodiment of a user interface showing a CREATE GROUP screen for an application which eases the use of the system 100 to assign text names for groups of aliases and or one or more recipient device 104 identifiers, such as “Team A”, which might include ten or more recipient device 104 identifiers. In some embodiments, the CREATE GROUP feature works essentially like the CREATE ALIAS screen as described in FIG. 5D: using the subscriber's Contact List format and the the Create Group Screen 150 the user can create groups 151 for recipient device 104 identifiers, display 154 the selected identifiers 153 and Groups 155, and add, change and delete groups 152 by selecting identifiers 159 that have been previously called by having been texted directly, but that lack a contact name. In other embodiments, the user is able to select aliases 158 for combining with contacts 157 from the list 156 and identifiers into members of a group 154.

FIG. 5F is a screen representation view of an embodiment of a user interface showing the MAKE PAYMENTS/SEE BALANCE screen for an application created to ease the use of the system 100 to recharge the user account balance by sending text messages that will cause various 3^{rd} party payment services to send money to the system 100 and have it credited to the subscriber's account using a standardized set of the system's commands which are then translated to each of the 3^{rd} party payment services' unique command sequence. In one embodiment, the subscriber selects the Pay/See Balance screen 160 and selects which 3^{rd} party payment service 162 under pay by 161 he wishes to use to make a payment to his prepaid account. Depending on which service is to be used, the subscriber may either enter a prepaid receipt number 163 for which the entire value of the prepaid ticket will be applied to the subscriber's account, such as a transaction via the PAYSAFE system described above in reference to FIG. 1. In another embodiment, the user can enter the amount 167 of money he or she wishes to transfer from an account of a third party payment processor 166 whereby they have a balance, such as in the PAYPAL system described above in reference to FIG. 1. In another embodiment, the user can also query to display the current balance 164 remaining on the subscriber's prepaid account 165.

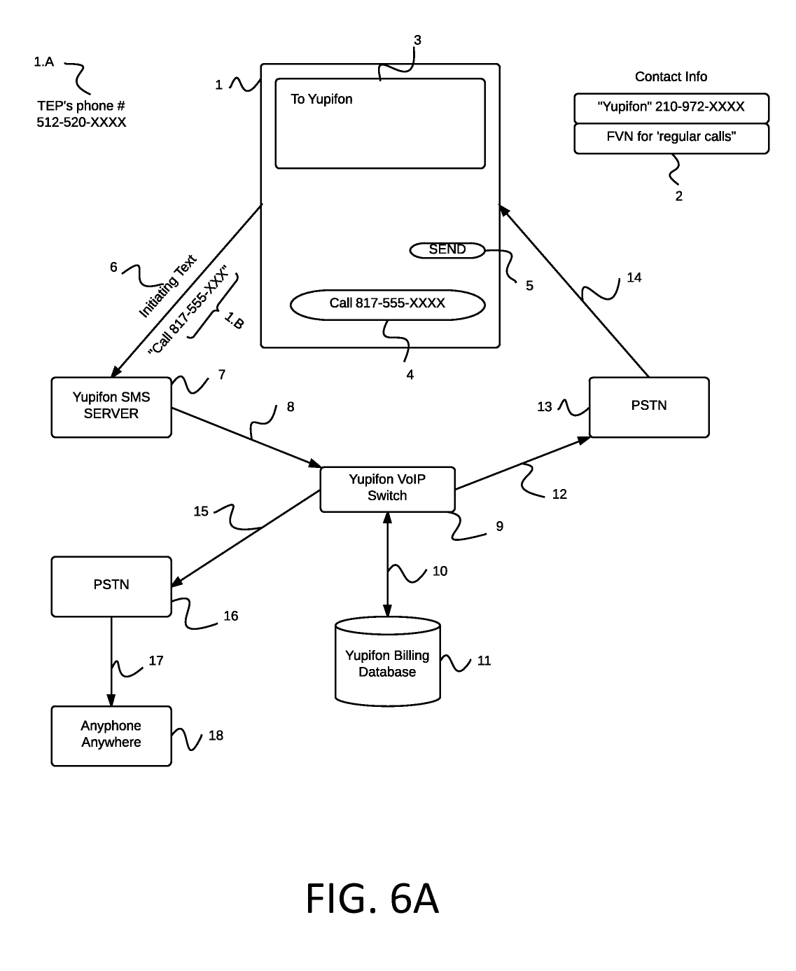

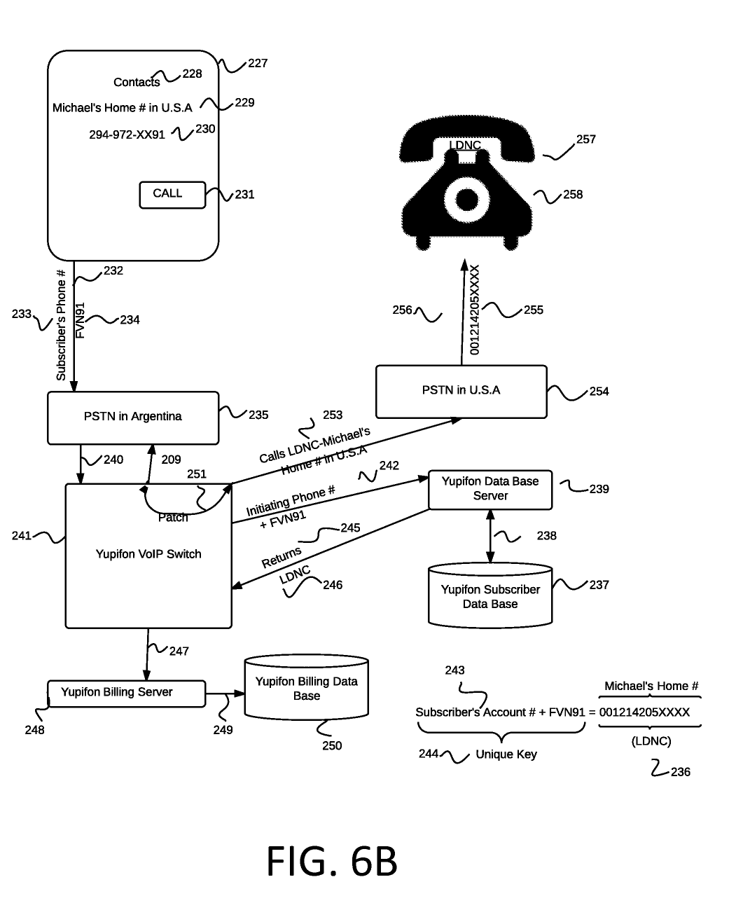

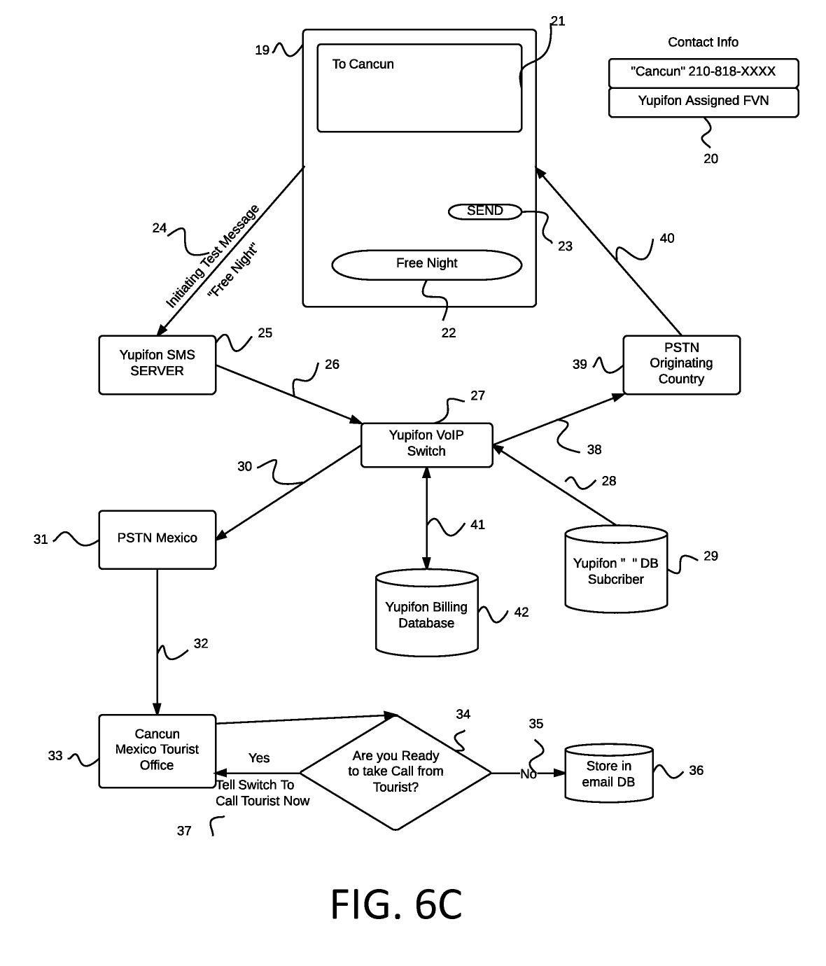

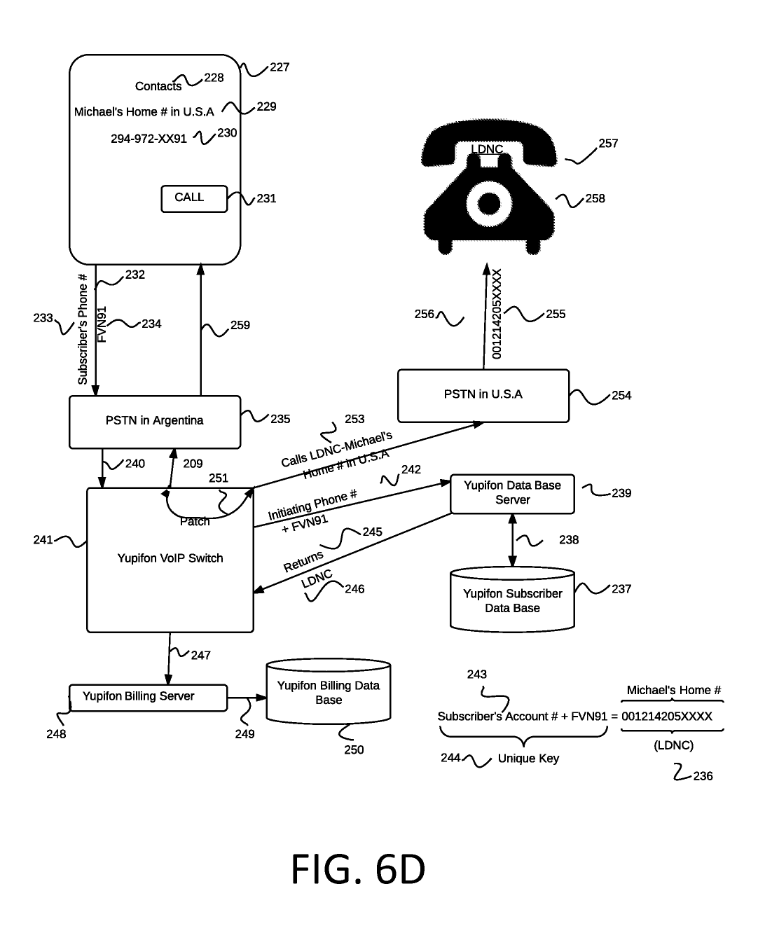

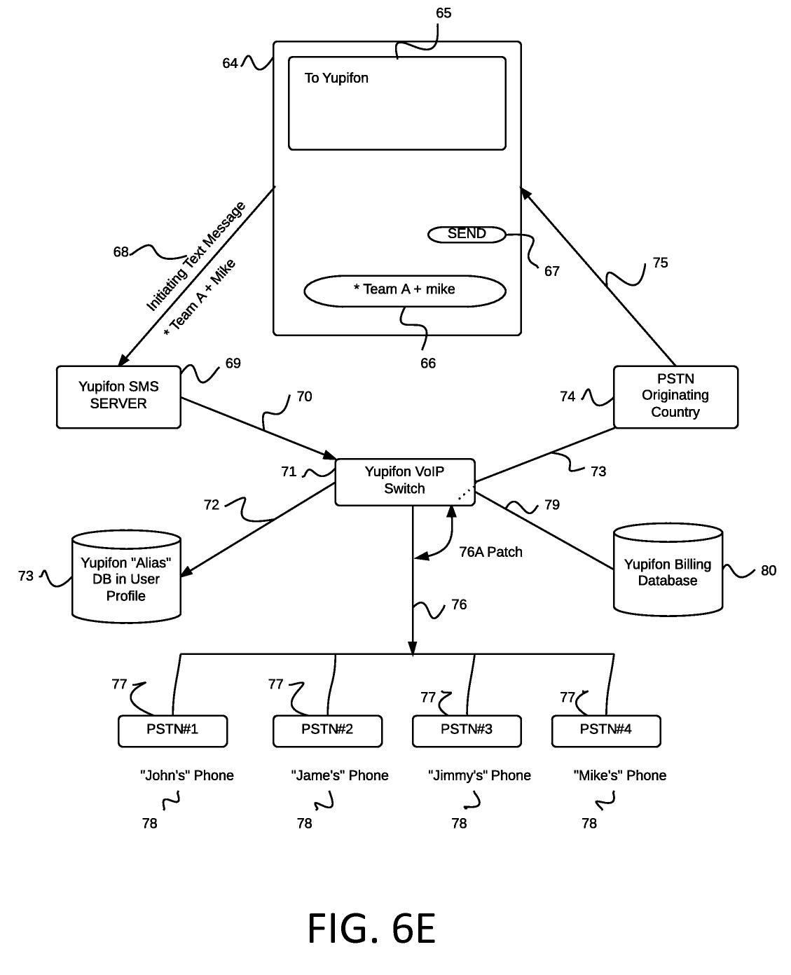

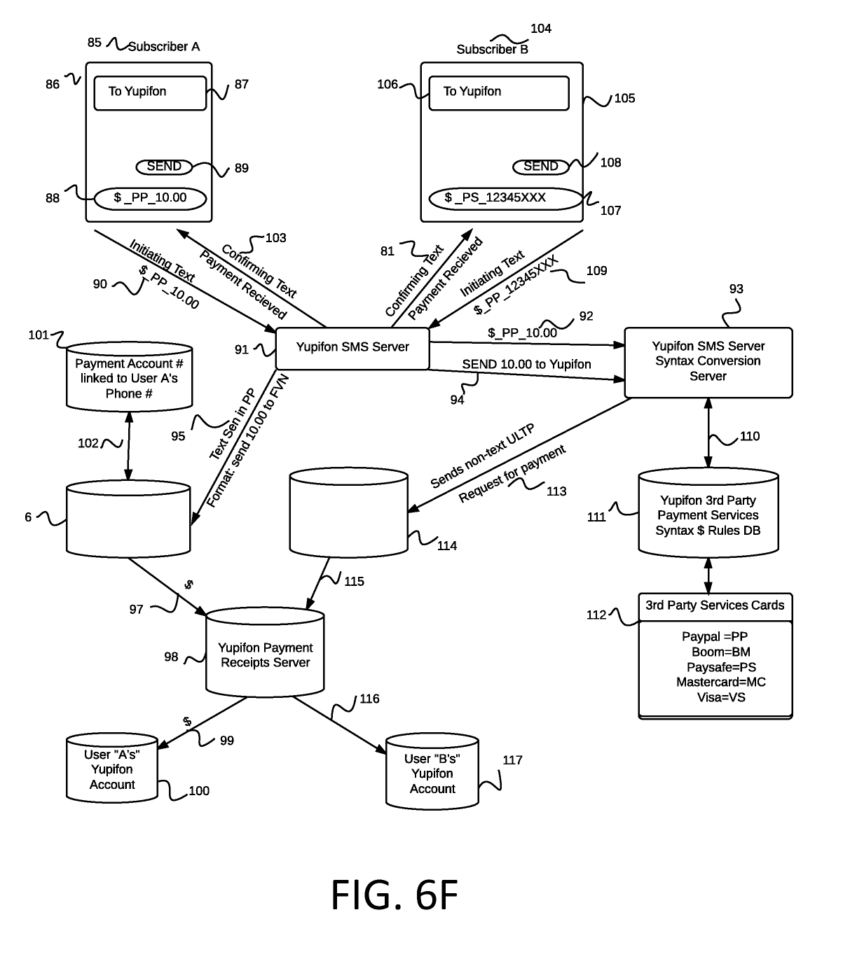

FIGS. 6A-6F illustrate some further exemplary implementations of embodiments of the method 200. These exemplary illustrations are only provided to assist in understanding the functioning of the method 200 and are not intended to limit the scope of the method 200 as described herein.

FIG. 6A is a block diagram view of an exemplary embodiment of the present invention for initiating and completing long distance VoIP phone calls between one texting enabled phone and any other type of phone, by way of the call-originating phone 1 sending an initiating text message to the VoIP switch's SMS server. In one embodiment, an owner of a the call-originating phone 1 either texts directly to a short code or a forwarding virtual number or sets up a contact entry in his phone's contact list 2 giving, a human readable name 3 for the system 7 entering the system's domestic forwarding virtual number or short code for texting to the Service's SMS server as the contact's “phone number” 2 used in the method 200 described above in reference to FIG. 2. The owner of the phone becomes a caller when he or she 1 selects the human readable contact name 3 for the system's SMS server's testing number 7 and enters a long distance (international) phone number to be called in the message area 4 of the phone's text messaging program, and presses “send” 5 thus sending said text message 6 to the Service's SMS server 7. In some embodiments, the system's SMS server 7 transmits 8 the text message's 7 information, including the phone number 1.A of the call-originating phone and the long distance number to be called 1.B to the system's VoIP switch 9. The system's VoIP switch 9 may query 10 the system's billing database 11 to verify that the sending call-originating phone's 1 phone number 1.A has a valid service account and adequate funds to make and complete the phone call. In another embodiment, where the call is a first time “free” call, then the subroutine in 1.A.1 is invoked. The system's VoIP switch 9 may call 12 the call-originating phone's 1 PSTN switch 13, which then may terminate (place) a call 14 through to the initiating call-originating phone 1 by calling its number 1.A. In some embodiments, if the caller answers 14 the incoming call on the call-originating phone 1 then the VoIP switch 9 may call 12 the recipient device phone 1.B by calling 15 the desired long distance phone number's 1.B PSTN switch 16 which then terminates (completes) the call 17 through to the desired phone 1.B, and the two calls are then “patched” together (merged) by the VoIP switch 9.

FIG. 6B is a block diagram view of another implementation of the system and method, depicting a subscriber initiating and completing a long distance VoIP phone call from any type of phone to any other type of phone located anywhere in the world by calling an assigned domestic forwarding virtual number for an identifier of a recipient device listed under the subscriber's account, as set forth above in reference to FIG. 2. In one embodiment, a subscriber in the country of service (COS) then uses his or her phone 227 to place the call 231 to the forwarding virtual number 230 connected to the identity or name of the subscriber's contacts 229 found in the subscriber's contact list 228. In some embodiments, the call 231 transmits 232, among other information, the phone number from the phone 227 from which the call was initiated (the “Subscriber's phone number”) 233 and the domestic forwarding virtual number that the system assigned to the subscriber to be used to call 234 to the PSTN 235 which forwards the call 240 to the VoIP switch 241. Before initiating a call in some embodiments, the subscriber enters into his phone's contact list 228 the name or identity of the contact (such as “Mom” or “Group A” or “Nick's Cell in China”) 229 for the forwarding virtual number 230 used by the invention's calling process to call the recipient device 236. The phone number of the recipient device 236 may be stored in the system's subscriber database 237 linked 238 to a database server 239, and may linked to the subscriber's account and to the assigned forwarding virtual number. In some embodiments, the call is directed 240 to the system's VoIP switch 241, which receives two key data elements, the subscriber's phone number 233 and the assigned forwarding virtual number, and passes those two data points 242 in the form of a data base query to the service's data base server 239. In an embodiment, the data base server 239 then looks up the subscriber's account number 243 by cross-indexing from the subscriber's phone number gleaned from the calling data from the subscriber's phone call connecting with the system's VoIP switch 241 and then looking up the recipient device number 236 associated with the assigned forwarding virtual number by the unique data lookup key 244. The unique key may be comprised of the subscriber's account number 243 plus the assigned forwarding virtual number, thus providing the number of the recipient device 236, which can be a plurality of numbers depending upon the contact 229. The system's database server 239 may answer the query 245 from the database server by providing it with one or a plurality of recipient device numbers 246. When the call is completed in some embodiments, the VoIP switch 241 then forwards the billing information (such as the call's duration) 247 to the subscriber's account on the system's billing server 248 which then posts 249 the transaction to the system's billing data base 250. In some embodiments, the VoIP switch 241 then creates a patch 251 between the subscriber's phone number 233 and the individual recipient device being called 252 by the VoIP switch 241. The VoIP call 253 may go to the localized PSTN switch 254 in the country where the recipient device 255 now being called 256 is located. The recipient device 257 associated with the recipient device phone number being called 255 may receive an incoming call 258 which may be then be answered and the VoIP switch may patch 251 the two calls together.

FIG. 6C is a block diagram view another exemplary implementation of an embodiment providing for a call-originating phone initiating and completing a toll free long distance VoIP phone call to a subscribing entity, such as an international business or other organization, thus mimicking an international 1-800 service by the call-originating phone sending an initiating text message to the Service's SMS server, as described above in reference to FIG. 2. In one embodiment, the caller uses his or her texting enabled phone 19 to enter and then text the recipient device phone number directly to a SMS forwarding virtual number or short code 20. In another embodiment, the caller sets up a contact entry with a human readable name for the SMS service with the system's SMS forwarding virtual number or short code entered as the contract's phone number 21 and then the caller types in a keyword into the message area of the call-originating phone's texting program 22; the keyword may be provided by a subscribing entity, normally through advertising 33, that has subscribed for a type of international analog to a 1-800 service employing the system. In some embodiments, the call-originating phone's user initiates the request for the offer (i.e. “free night in Cancun”) by sending 23 a text message containing the keyword 24 to the SMS forwarding virtual number or short code 20 that points to the system's SMS server 25. The SMS server 25 may forward 26 to the VoIP switch 27 the calling information including the call-originating phone's 1 phone number 1.A and the SMS number called and the keywords in the message nearest the key 20 for the subscribing entity, so that the VoIP switch can query 28 a subscriber database 29 to determine that the subscribing entity has a valid account and then query 41 a billing database 42 to determine if the subscribing entity has adequate credit in or for its account to complete the phone call. In some embodiments, if both cases are in the affirmative, the VoIP switch then calls 30 the subscribing entity's PSTN 31 which then terminates (completes) the call 32 through to the subscribing entity 33. The Service's VoIP switch 27 may then query 34 the Subscribing Entity 33 as to whether or not the subscribing entity 34 is ready to have the call completed through to the call-originating phone 1. If the answer is “NO” 35 then the information may be stored 36 to be completed at some future point in time. If the Subscribing Entity's 33 answer to the VoIP switch's 27 query 34 is “YES” 37, then the Service's VoIP switch 27 may call 38 the call-originating phone's 19 PSTN switch 39 and terminate (completes) the call 40 through to the call-originating phone 19 and patch the two calls together within the VoIP switch 27. Charges for the service provided by the Service for the Subscribing Entity may then be billed 41 to the subscribing entity's 33 account in the system's billing database 42.

FIG. 6D is a block diagram view of an exemplary implementation of an embodiment, depicting a subscriber initiating and completing a long distance VoIP phone call from any type of phone to any other type of phone by calling an assigned domestic forwarding virtual number for the listed recipient device, in this example making use of the invention's call back feature. In one embodiment, a subscriber in the country of service (COS) uses his or her phone 227 to place the call 231 to the forwarding virtual number 230 connected to the identity or name of the subscriber's contacts 229 found in the subscriber's contact list 228. In some embodiments, the call 231 transmits 232, among other information, the phone number from the phone 227 from which the call was initiated (the “subscriber's phone number”) 233 and the domestic forwarding virtual number that the Service assigned to the subscriber to be used to call 234 to the PSTN 235, which forwards the call 240 to the VoIP switch 241, which immediately drops the call 209 and call backs the call-originating phone thus making it an “in-bound” call to the subscriber 259. Before initiating a call, the Subscriber may enter into his or her phone's contact list 228 the name or identity of the Contact (such as “Mom” or “Group A” or “Nick's Cell in China”) 229 for the forwarding virutal number 230 used by the invention's calling process to call the recipient device 236. The number of the recipient device 236 may be stored in the system's subscriber database 237 linked 238 to the database server 239; the number may be linked to the subscriber's account and to the assigned forwarding virtual number. In one embodiment, the call is directed 240 to the system's VoIP switch 241, which receives two key data elements, the subscriber's phone number 233 and the assigned forwarding virtual number, and passes those two data points 242 in the form of a data base query to the system's database server 239. The database server 239 then looks up the subscriber's account number 243 by cross-indexing from the subscriber's phone number gleaned from the calling data from the subscriber's phone call connecting with the VoIP switch 241 and then looking up the recipient device 236 associated with the assigned forwarding virtual number by the unique data lookup key 244. The unique key may be comprised of the subscriber's account number 243 plus the assigned forwarding virtual number, thus providing the identifier of the recipient device 236, which may be a plurality of numbers depending upon the contact 229. In some embodiments, the system's database server 239 answers the query 245 from the database server by providing it with one or a plurality of numbers for recipient devices 246. In some embodiments, when the call is completed, the VoIP switch 241 then forwards the billing information (such as the call's duration) 247 to the subscriber's account on the system's billing server 248 which then posts 249 the transaction to the system's billing data base 250. The VoIP switch 241 may then create a patch 251 between the subscriber's phone number 233 and the individual phone number of the recipient device being called 252 by the VoIP switch 241. The VoIP call 253 may go to the localized PSTN switch 254 in the country where the recipient device 255 now being called 256 is located. In some embodiments, the recipient device 257 associated with the number being called 255 receives an incoming call 258 which may be then be answered and the VoIP switch patches 251 the two calls together.

FIG. 6E is a block diagram view of an exemplary embodiment whereby a call-originating phone initiates and completes long distance VoIP conference calls between multiple parties by sending an initiating text message to the system's SMS server. In some embodiments, the call-originating phone's 64 contact list entry for the system is accessed 65 (or the SMS forwarding virtual number or short code is entered manually) and the command is entered to CALL 66 which may be the word CALL or its equivalent in another language such as “LLAME” (in Spanish) or a mnemonic such as “CL” or even a symbol such as “*” (or even defined to not require my prefix command at all) followed by the number, alias and or group to be called. In some embodiments, the text is then sent 67 by pressing “SEND” which then sends the text message 68 to the system's SMS server 69 which then forwards text's information 70 to the VoIP Switch 71 which accesses 72 its caller profile database 73 to translate the group(s) and or “aliases” into the phone numbers which the VoIP switch is to call 71 after the VoIP Switch first calls the call-originating phone 73 through the call-originating phone's cell service PSTN 74 to connect with the call-originating phone so the caller may answer the call 75. In some embodiments, after the call-originating phone 64 has connected with the VoIP Switch 71 by virtue of the caller answering the incoming call from the VoIP Switch 71, the VoIP switch 71 then calls the phone numbers 76 through their respective PSTNs 77 and connects with the respected individual phone number listed in the group 78 for the conference call, and then patches 76B the group phone numbers to the call-originating phone's call. In some embodiments, when the call is complete, the VoIP Switch's data, including such elements as length of the phone calls, the phone numbers and countries called, is forwarded 79 to the system's billing database 80 in order to calculate the charges and post them to the subscriber's account.

FIG. 6F is a block diagram view of an exemplary implementation providing for a call-originating phone to initiate and complete a payment (recharging) of a subscriber's account by the call-originating phone sending an initiating a payment request by text message to the system's SMS server. The diagram depicts how two different subscribers recharge their respective service accounts by texting commands using two different third party prepaid payment services. In one first exemplary embodiment, Subscriber A 85 uses the call-originating phone 86 and selects the system's contact entry in his call-originating phone's contact's list 87, types in the payment command, which may be the special character “$,” indicating the payment is to be made via a first payment provider 88, and requesting that the provider apply a payment of $10 to his or her account with the system. The payment request text 88 may then be sent 89 by tapping the call-originating phone's “Send” button; in one embodiment, the text may then be forwarded in 90 to the SMS Server 91 which recognizes the text message as a payment request and thus forwards the text 92 to a payment request syntax conversion server 93 which translates the payment request into the proper payment request structure for the first payment processor and returns the translated payment request text message 94 to the SMS server 91 so that it can send the translated text message 95 to the first payment processor's payment request SMS server 96. In one embodiment, the SMS server 91 replaces the SMS server's forwarding virtual number or short code with that of Subscriber A's phone, 85 which then forwards the payment request to the payment processing server 96; the payment processing server may then look up Subscriber A's 85 account information by performing a cross indexed lookup of the Subscriber A's call-originating phone's 86 number. In one embodiment, using the payment account number 101 linked 102 to Subscriber A linked to the first payment processor 96, the first payment processor 96 then forwards the requested payment 97 to the system's payment receipts server 98 which then sends and posts the payment 99 to Subscriber A's account 100 with the system. The system's SMS server may sends Subscriber A's call-originating phone 86 a confirmation text 103 acknowledging the payment has been credited to his or her account.

In another embodiment Subscriber B 104 uses his call-originating phone 105, selects the system's contact entry in his call-originating phone's contact's list 106, and types in the payment command, using the special character “$” that indicates the payment is to be made via third party services. In one embodiment, the payment request text 107 is sent 108 and then forwarded 109 to the system SMS server 91, which recognizes the text message as a payment request and thus forwards the text 92 to the system's payment request syntax conversion server 93. In an embodiment, the payment request syntax conversion server 93 is linked 110 with a party payment services syntax money rules database 111, which recognizes acceptable third party services cards 112. In some embodiments, after recognizing Subscriber B's 104 requested form of payment the conversion Server 93 sends a non-text ULTP request for payment 113 to a prepaid receipt number 114 associated with Subscriber B's account at a second third party payment processor. The requested payment may then forwarded 115 on to the payment receipts server 98 which may post the payment 116 to Subscriber B's account 117 with the system, in some embodiments. The SMS server may send Subscriber B's call-originating phone 105 a confirmation text 81 acknowledging the payment has been received.

In a further embodiment, first-time caller who is not already listed under a subscriber's account may “try out” the system, by texting the desired recipient device 104 identifier to the system's SMS server's forwarding virtual number or short code. In an embodiment, the system will send a welcoming message to the first time caller explaining that the first call is a free call of a certain duration and that there will be a beep on the call when there is one only minute of service left on the call. In some embodiments, after the free call has been completed the system's SMS server texts a message to the first time caller's phone offering the option for the system to assign an “Alias” to the number just called (i.e. “Mom” or “Maria”). In another embodiment, the first time caller may also be given the option to have a domestic forwarding virtual number assigned for that recipient device 104 number, so that the Caller may simply create a Contact Entry listed as either “Mom” or “Maria” in his contact list with that domestic forwarding virtual number as the person's “domestic” phone number, to call in the future as disclosed above in reference to FIG. 2. An additional text may also be sent to the first time caller explaining how the caller (who is now also a subscriber, having completed the first free call) may “charge” (make a prepaid payment to his new account) using various third party payment services. In some embodiments, a person calling a recipient device 104 for the first time is offered the ability to create an alias for the recipient device 104 according to any method disclosed above in reference to FIG. 2.

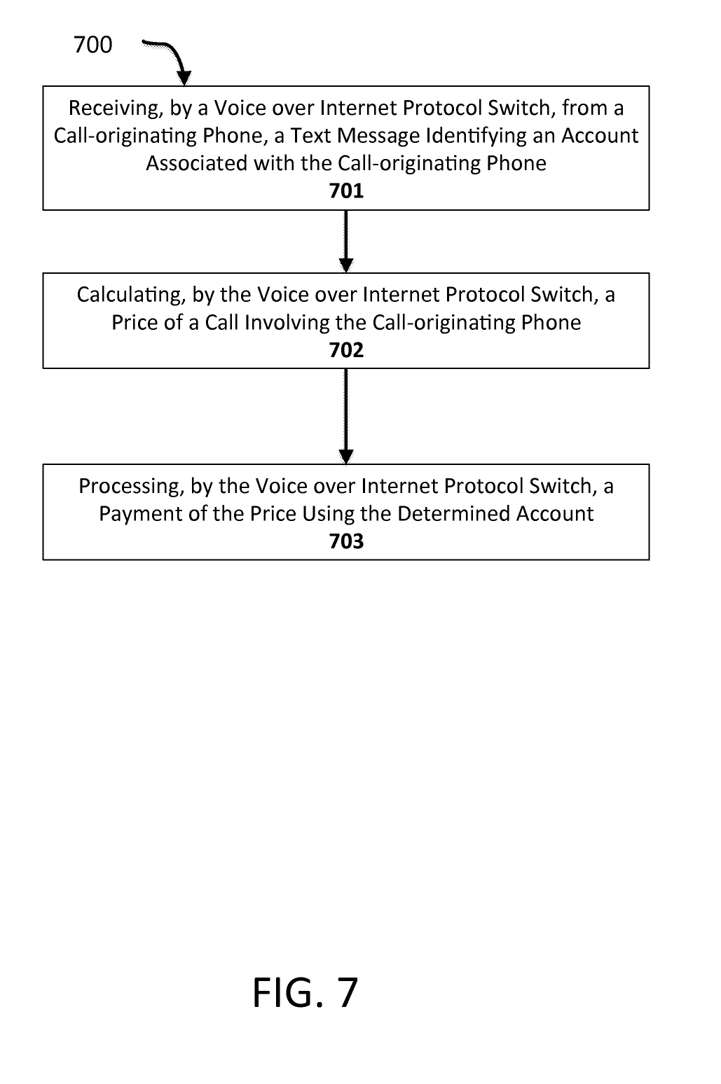

FIG. 7 illustrates an embodiment of a method 700 for processing payments for phone calls using text messaging. The method 700 includes receiving, by a Voice over Internet Protocol switch, from a call-originating phone, a text message identifying an account associated with the call-originating phone (701). The method 700 includes calculating, by the Voice over Internet Protocol switch, a price of a call involving the call-originating phone (702). The method 700 includes processing, by the Voice over Internet Protocol switch, a payment of the price using the determined account (703).

Referring to FIG. 7 in greater detail, and by reference to FIG. 1, the call-originating phone 103 sends data identifying the call-originating phone and the recipient device 104 to the VoIP switch 101 (701). In some embodiments, this is implemented as disclosed above in reference to FIG. 2.

The VoIP switch 101 calculates a price of a call involving the call-originating phone (702). In some embodiments, this is implemented as disclosed above in reference to FIG. 2.The VoIP switch 101 processes a payment of the price using the determined account (703). In some embodiments, this is implemented as disclosed above in reference to FIG. 2.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for initiating Voice over Internet Protocol communication, the method comprising:
receiving, by a Voice over Internet Protocol switch, data identifying a call-originating phone and data identifying at least one recipient device;
creating, by the Voice over Internet Protocol switch, a first Voice over Internet Protocol call to the call-originating phone using the data identifying the call-originating phone;
creating, by the Voice over Internet Protocol switch, a second Voice over Internet Protocol call to the at least one recipient device using the data identifying the at least one recipient device; and
combining, by the Voice over Internet Protocol switch, the first call with the second call.

2. The method of claim 1, wherein receiving further comprises receiving, from the call-originating phone, the data identifying the call-originating phone and the data identifying at least one recipient device.

3. The method of claim 1, wherein receiving further comprises receiving, via non-packet-based network communication, the data identifying the call-originating phone and the data identifying at least one recipient device from the call-originating phone.

4. The method of claim 3, wherein the non-packet-based network communication is a text message.

5. The method of claim 3, wherein the non-packet-based network communication is a phone call placed using the first publically switched telephone network.

6. The method of claim 5 wherein the Voice over Internet Protocol switch receives the data via the user's voice input in response to a series of prompts provided by the Voice over Internet Protocol switch.

7. The method of claim 1, wherein the data identifying the call-originating phone further comprises a first telephone number associated with the call-originating phone.

8. The method of claim 1, wherein the data identifying the call-originating phone further comprises data identifying a first country within which call-originating phone is located.

9. The method of claim 1, wherein the data identifying the call-originating phone further comprises data identifying a first person or entity associated with the call-originating phone.

10. The method of claim 1 wherein the data identifying the at least one recipient device further comprises a first IP address associated with the call-originating phone.

11. The method of claim 1, wherein the data identifying the at least one recipient device further comprises a second telephone number associated with the at least one recipient device.

12. The method of claim 11 further comprising:
detecting, by the Voice over Internet Protocol switch, that the second telephone number does not include a country code;
retrieving, by the Voice over Internet Protocol switch, a first country code associated with the second telephone number; and
automatically appending, by the Voice over Internet Protocol switch, the first country code to the second telephone number.

13. The method of claim 12, wherein the Voice over Internet Protocol switch receives the first country code in the data identifying the call-originating phone.

14. The method of claim 1, wherein the data identifying the at least one recipient device further comprises a second country within which the at least one recipient device is located.

15. The method of claim 1, wherein the data identifying the at least one recipient device further comprises data identifying at least one second person or entity associated with the recipient device.

16. The method of claim 1 wherein the data identifying the at least one recipient device further comprises a second IP address associated with the at least one recipient device.

17. The method of claim 1, wherein creating the first Voice over Internet Protocol call further comprises creating the first Voice over Internet Protocol call using a using a first publically switched telephone network.

18. A method according to claim 1, wherein creating the second call further comprises creating a Voice over Internet Protocol session with the at least one recipient device using a packet-based network communication protocol.

19. A method according to claim 1, wherein creating the second call further comprises creating a telephone call using a second publically switched telephone network to the recipient device.

20. The method of claim 1, wherein creating the second Voice over Internet Protocol call further comprising creating a Voice over Internet Protocol call to a plurality of recipient devices.

21. The method of claim 1 further comprising:
receiving, by the Voice over Internet Protocol switch, data specifying a particular time and date; and
postponing, by the Voice over Internet Protocol switch, the creation of the first Voice over Internet Protocol call and the second Voice over Internet Protocol call, until the particular time and date.

22. The method of claim 1 further comprising:
determining that a first country code associated with the call-originating phone differs from a second country code associated with the at least one recipient device; and
placing at least one of the first call and the second call via international long distance.

23. The method of claim 1 further comprising:
locating, by the Voice over Internet Protocol switch, at least one payment account associated with at least one of the call-originating phone and the at least one recipient device.

24. The method of claim 23 further comprising:
verifying, by the Voice over Internet Protocol switch that the at least one payment account contains sufficient funds to initiate the first Voice over Internet Protocol call and the second Voice over Internet Protocol call; and
charging, by the Voice over Internet Protocol switch, the at least one payment account for the first Voice over Internet Protocol call and the second Voice over Internet Protocol call.

25. The method of claim 23 further comprising:
determining, by the Voice over Internet Protocol switch, that the at least one payment account does not contain sufficient funds to initiate the first Voice over Internet Protocol call and the second Voice over Internet Protocol call;
prompting, by the Voice over Internet Protocol switch, a user of at least one of the call-originating phone and the at least one recipient device to provide a method of payment;
receiving, by the Voice over Internet Protocol switch, the method of payment from the user; and
charging, by the Voice over Internet Protocol switch, the received method of payment for the first Voice over Internet Protocol call and the second Voice over Internet Protocol call.

26. The method of claim 1, further comprising charging, by the Voice over Internet Protocol switch, the cost of the first Voice over Internet Protocol call and the second Voice over Internet Protocol call to a phone bill associated with the call-originating phone.

27. The method of claim 1 further comprising:
prompting, by the Voice over Internet Protocol switch, a user of the call-originating phone to create a user account;
receiving, by the Voice over Internet Protocol switch, an agreement to create the user account; and
creating a user account using the data identifying the call-originating phone.

28. The method of claim 27 further comprising:
prompting, by the Voice over Internet Protocol switch, the user to provide billing data;
receiving, by the Voice over Internet Protocol switch, billing data from the user; and
adding, by the Voice over Internet Protocol switch, the billing data to the user account.

29. The method of claim 26 further comprising:
adding, by the Voice over Internet Protocol switch, a promotional credit having a value to the user account; and
deducting, by the Voice over Internet Protocol switch, the value of the promotional credit from a cost of the first Voice over Internet Protocol call and the second Voice over Internet Protocol call using the promotional credit.

30. A system for telephone-initiated Voice over Internet Protocol communication, the system comprising:
at least one call-originating phone;
at least one recipient device; and
at least one Voice over Internet Protocol switch configured to receive data identifying the call-originating phone and data identifying at least one recipient device, to create a first Voice over Internet Protocol call to the call-originating phone, to create a second Voice over Internet Protocol call to the recipient device using the second publically switched telephone network, and to combine the first call with the second call.
